(19) United States
(12) Patent Application Publication
(10) Pub. No.: US 2025/0219723 A1
(43) Pub. Date: Jul. 3, 2025

(54) COMMUNICATION DEVICE, COMMUNICATION METHOD, AND COMMUNICATION SYSTEM

(71) Applicant: SONY GROUP CORPORATION, TOKYO (JP)

(72) Inventors: KAI SUZUKI, TOKYO (JP); KYOHEI IWAMOTO, TOKYO (JP); HIROMITSU KOMATSU, TOKYO (JP); HIROAKI YAMAZOE, TOKYO (JP); TAIJI ITO, TOKYO (JP)

(21) Appl. No.: 18/848,439

(22) PCT Filed: Mar. 23, 2023
(86) PCT No.: PCT/JP2023/011536

§ 371 Date: Sep. 18, 2024

(30) Foreign Application Priority Data
Mar. 25, 2022 (JP) 2022-050721

(51) Int. Cl. H04B 7/185; H04B 10/50

(52) U.S. Cl. CPC H04B 7/18558; H04B 7/18547; H04B 10/503

(57) ABSTRACT

A communication device (40) of the present disclosure includes a first communication unit (42), a second communication unit (45), and a control unit (46). The first communication unit (42) performs first communication using a packet with a satellite station (40N). The second communication unit (45) performs second communication using a beacon with the satellite station (40N). Via the first communication unit (42), the control unit (46) transmits the packet to the satellite station (40N) with which the second communication using the beacon is performed via the second communication unit (45).

### FIELD

The present disclosure relates to a communication device, a communication method, and a communication system.

### BACKGROUND

A technology of transmitting data from one place to another place on the ground by using a plurality of satellites has been known. In this technology, a satellite creates a wireless path between ground stations via wireless links between a plurality of satellites.

In addition, in another technology, a network controller acquires information from a node including a satellite, and determines a network configuration including a routing path on the basis of the acquired information.

### CITATION LIST

### Patent Literature

Patent Literature 1: JP 2021-506153 A
Patent Literature 2: Japanese Patent Application Laid-open No. 2022-3816

### SUMMARY

### Technical Problem

However, in a case where a satellite is a non-geostationary orbit satellite, the satellite is moving at a high speed. Thus, in a case where a network is configured by utilization of a plurality of non-geostationary orbit satellites, a combination of satellites that can perform direct communication, a satellite that can communicate with a ground station, and the like change constantly. That is, the network configuration constantly changes.

In a constantly changing network configuration, it is not easy to search for an appropriate path in order to transmit data from a terminal device on the ground to another terminal device. For example, in the above-described technology, in order to search for an appropriate path, it is desirable that a node to determine the path holds the latest information related to satellites.

Thus, the present disclosure provides a mechanism capable of more easily determining an appropriate path.

Note that the above problem or object is merely one of a plurality of problems or objects that can be solved or achieved by a plurality of embodiments disclosed in the present specification.

### Solution to Problem

A base station of the present disclosure includes a control unit. The control unit determines allocation information of a radio resource related to reception data received periodically. The control unit transmits the allocation information to terminal device. The reception data is specified by an arrival time of data burst, a period, and a protect window. The allocation information of the radio resource is determined on the basis of at least one of the arrival time of data burst, the period, and the protect window.

### BRIEF DESCRIPTION OF DRAWINGS

FIG. 1 is a view illustrating an overall configuration example of a satellite communication system according to a first embodiment of the present disclosure.

FIG. 2 is a view for describing an example of a satellite station according to the first embodiment of the present disclosure.

FIG. 3 is a view illustrating an example of a cell including a satellite station according to the first embodiment of the present disclosure.

FIG. 4 is a view illustrating an outline of communication processing according to the first embodiment of the present disclosure.

FIG. 5 is a block diagram illustrating a configuration example of a terminal device according to the first embodiment of the present disclosure.

FIG. 6 is a block diagram illustrating a configuration example of a ground station according to the first embodiment of the present disclosure.

FIG. 7 is a block diagram illustrating a configuration example of a satellite station according to the first embodiment of the present disclosure.

FIG. 8 is a table illustrating an example of correspondence information stored in the satellite station according to the first embodiment of the present disclosure.

FIG. 9 is a flowchart illustrating an example of a flow of a packet transfer processing according to the first embodiment of the present disclosure.

FIG. 10 is a flowchart illustrating an example of a flow of correspondence information transmission processing according to the first embodiment of the present disclosure.

FIG. 11 is a block diagram illustrating a configuration example of a satellite station according to a second embodiment of the present disclosure.

FIG. 12 is a table illustrating an example of adjacent satellite station information according to the second embodiment of the present disclosure.

FIG. 13 is a flowchart illustrating an example of a flow of communication processing according to the second embodiment of the present disclosure.

FIG. 14 is a block diagram illustrating a configuration example of a satellite station according to a third embodiment of the present disclosure.

FIG. 15 is a flowchart illustrating an example of a flow of communication processing according to the third embodiment of the present disclosure.

### DESCRIPTION OF EMBODIMENTS

In the following, embodiments of the present disclosure will be described in detail with reference to the accompanying drawings. Note that the same reference signs are assigned to components having substantially the same functional configuration, and overlapped description is omitted in the present specification and the drawings.

Furthermore, in the present specification and the drawings, similar components of embodiments may be distinguished by assignment of at least one of different alphabets or numbers after the same reference sign. However, in a case where it is not specifically necessary to distinguish the similar components from each other, only the same reference sign is assigned. For example, a plurality of configurations having substantially the same functional configuration is distinguished as a terminal device 10_1 and a terminal device 10_2 as necessary. For example, in a case where it is not specifically necessary to make a distinction, the terminal device 10_1 and the terminal device 10_2 are simply referred to as a terminal device 10.

Each of one or a plurality of embodiments (including examples, modification examples, and application examples) described in the following can be performed independently. On the other hand, at least a part of the plurality of embodiments described in the following may be appropriately combined with at least a part of the other embodiments and performed. The plurality of embodiments may include novel features different from each other. Thus, the plurality of embodiments can contribute to solving objects or problems different from each other, and can exhibit effects different from each other.

### 1. FIRST EMBODIMENT

### 1.1. Configuration Example of a Satellite Communication System

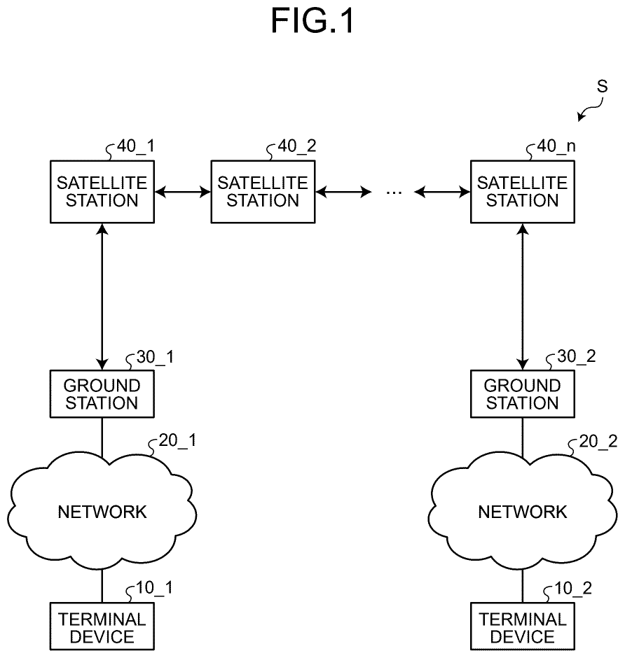

FIG. 1 is a view illustrating an overall configuration example of a satellite communication system S according to the first embodiment of the present disclosure. The satellite communication system S illustrated in FIG. 1 includes a terminal device 10, a ground station 30, and a satellite station 40.

The terminal device 10 is a communication device that communicates with another device. The terminal device 10 is, for example, a sensor or a camera device having a communication function, a mobile phone, a smart device (smartphone or tablet), a personal digital assistant (PDA), or a personal computer. The terminal device 10 may be a head mounted display, VR goggles, or the like having a function of transmitting and receiving data in a wireless or wired manner. The terminal device 10 may be a moving body such as an automobile or a drone.

The terminal device 10 communicates with the ground station 30 via a network 20. Furthermore, a terminal device 10_1 performs communication (such as transmission and reception of data) with a terminal device 10_2 via the ground station 30 and the satellite station 40. Note that the network 20 is, for example, a cellular network, the Internet, or the like.

The ground station 30 is a base station installed on the ground. Here, “on the ground” means to be on the ground in a broad sense including not only being on land but also being in the ground, on the water, and under the water. Note that in the following description, description of a “ground station” may be replaced with a “gateway”.

Note that a base station of LTE may be referred to as an evolved Node B (eNodeB) or an eNB. Furthermore, a base station of NR may be referred to as a gNodeB or a gNB. In LTE and NR, a terminal device (also referred to as a mobile station or a terminal) may be referred to as user equipment (UE). Note that the terminal device is a type of communication device, and is also referred to as a mobile station or a terminal.

The ground station 30 communicates with the terminal device 10 via the network 20. Furthermore, the ground station 30 communicates with the satellite station 40. The ground station 30 performs, for example, spatial optical communication using a laser.

The satellite station 40 is a relay station that relays communication between the ground stations 30. The satellite station 40 communicates with another satellite station 40 and the ground station 30. The satellite station 40 performs, for example, spatial optical communication using a laser with the other satellite station 40 and the ground station 30.

For example, data transmitted from the terminal device 10_1 to the terminal device 10_2 is received by a ground station 30_1 via a network 20_1. The ground station 30_1 transmits the received data to a satellite station 40_1. The satellite station 40_1 transmits the data to a satellite station 40_n via satellite stations 40_2 . . . . The satellite station 40_n transmits the data to a ground station 30_2. The ground station 30_2 transmits the data to the terminal device 10_2 via a network 20_2.

As described above, in the satellite communication system S according to the present embodiment, the terminal device 10 located on the ground transmits and receives data via the satellite station 40.

Here, the satellite station is mainly divided into a geostationary satellite station and a non-geostationary orbit satellite station (such as a low earth orbit satellite station).

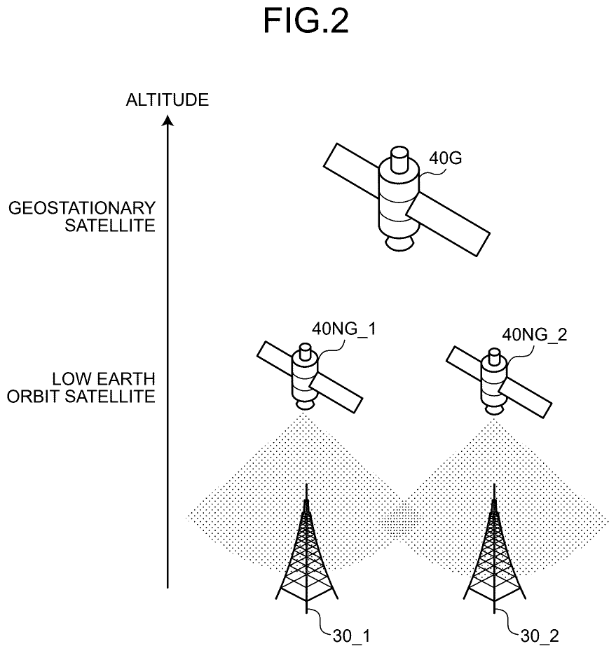

FIG. 2 is a view for describing an example of the satellite station 40 according to the first embodiment of the present disclosure. As illustrated in FIG. 2, the satellite station 40 includes a non-geostationary orbit satellite station 40NG and a geostationary satellite station 40G.

The geostationary satellite station 40G is located at an altitude of approximately 35786 km and revolves around the earth at the same speed as a rotation speed of the earth. A relative speed between the geostationary satellite station 40G and the ground station 30 on the ground is substantially 0, and the ground station 30 observes as if the geostationary satellite station 40G is stationary. The geostationary satellite station 40G communicates with the ground station 30 and the like located on the earth.

The non-geostationary orbit satellite station 40NG is a satellite station that orbits at a lower altitude than the geostationary satellite station 40G. The non-geostationary orbit satellite station 40NG is located, for example, at an altitude between 500 km and 2000 km.

A low earth orbit satellite constellation is formed by two or more (such as a several tens to several thousands) non-geostationary orbit satellite stations 40NG. Unlike the geostationary satellite station 40G, there is a relative speed between the non-geostationary orbit satellite stations 40NG and the ground station 30. It is observed by the ground station 30 as if the non-geostationary orbit satellite stations 40NG are moving. Each of non-geostationary orbit satellite stations 40NG_1 and 40NG_2 is included in a cell, and communicates with the ground stations 30_1 and 30_2, and the like located on the earth.

Note that in the present embodiment, the satellite station 40 that transfers data transmitted by the terminal device 10 is mainly the non-geostationary orbit satellite station 40NG. Hereinafter, unless otherwise specified, the satellite station 40 is the non-geostationary orbit satellite station 40NG.

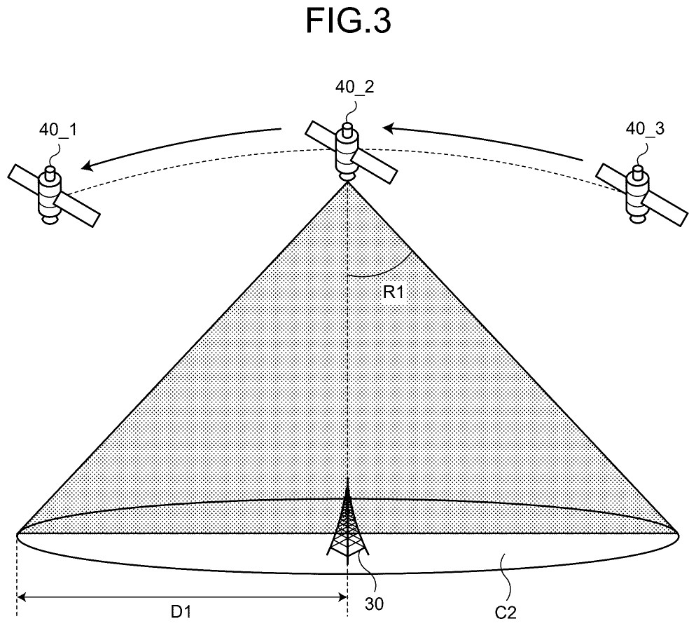

FIG. 3 is a view illustrating an example of a cell including the satellite station 40 according to the first embodiment of the present disclosure. A cell C2 formed by the satellite station 40_2 is illustrated in FIG. 3. The satellite station 40 orbiting in a low earth orbit communicates with the ground station 30 with predetermined directivity on the ground. For example, an angle R1 illustrated in FIG. 3 is 40°.

In a case of FIG. 3, a radius D1 of the cell C2 formed by the satellite station 40_2 is, for example, 1000 km. The satellite station 40 moves at a certain speed. In a case where it becomes difficult for the satellite station 40 to communicate with the ground station 30, a subsequent satellite station 40_3 provides communication. Note that the values of the angle R1 and the radius D1 described above are merely examples, and are not limited to the above.

As described above, the satellite station 40 moves on the orbit at a very high speed in the sky. For example, in a case of the satellite station 40 at an altitude of 600 km, the satellite station 40 moves on the orbit at a speed of 7.6 km/S. For example, in a case of radio frequency (RF) communication, although the satellite station 40 forms a cell (or beam) having a radius of several ten kilometers to several hundred kilometers on the ground, the cell formed on the ground also moves in accordance with the movement of the satellite. Thus, handover may be required even when the ground station 30 is not moving. For example, in a case where a cell diameter formed on the ground is 50 km and the ground station 30 is not moving, handover is generated in about 6 to 7 seconds.

### 1.2. Outline of Proposed Technology

As described above, in the satellite communication system S in which the network configuration constantly changes, for example, it is required to more easily determine an appropriate communication path between the terminal devices 10.

Thus, the satellite station 40 according to the first embodiment of the present disclosure performs first communication using a packet and second communication using a beacon with another satellite station 40. By using the first communication, the satellite station 40 transmits a packet (such as data from the terminal device 10) to the other satellite station 40 that has been able to perform the second communication using the beacon.

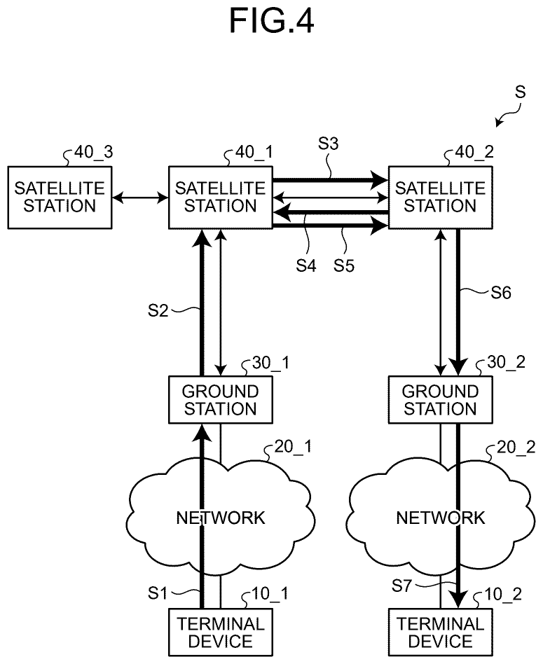

FIG. 4 is a view illustrating an outline of communication processing according to the first embodiment of the present disclosure. In an example of FIG. 4, the terminal device 10_1 transmits data to the terminal device 10_2.

The data transmitted by the terminal device 10_1 is first received by the ground station 30_1 via the network 20_1 (Step S1). Then, the ground station 30_1 transmits the received data to the satellite station 40_1 (Step S2).

The satellite station 40 transmits a beacon to the other satellite station 40_2 existing around the own station (Step S3). Here, for example, the satellite station 40 specifies the ground station 30_2 to which data is transmitted (transferred) from a destination of the data, and transmits the beacon to the satellite station 40_2 closer to the ground station 30_2 than the own device.

When receiving the beacon from the satellite station 40_1, the other satellite station 40_2 returns a beacon to the satellite station 40_1, for example (Step S4). In such a manner, the communication using a beacon (example of the second communication) is performed between the satellite stations 40_1 and 40_2.

In a case where there is a reply from the other satellite station 40_2, the satellite station 40_1 transmits (transfers) the data received from the ground station 30_1 to the other satellite station 40_2 (Step S5).

The other satellite station 40_2 transmits (transfers) the received data to the ground station 30_2 (Step S6). Note that in a case of not being able to directly communicate with the ground station 30_2, the other satellite station 40_2 transfers the data after performing the communication using a beacon with the other satellite station 40 existing around the own station.

The ground station 30_2 transmits the received data to the terminal device 10_2 via the network 20_2 (Step S7).

As described above, the terminal device 10_1 according to the present embodiment transmits the data to the terminal device 10_2 via at least one satellite station 40. The satellite station 40 according to the present embodiment performs the communication using a beacon (example of the second communication) with the other satellite station 40 according to a destination of the data (packet). The satellite station 40 performs communication (example of the first communication) with the other satellite station 40 with which the communication using a beacon is performed, and transfers the data (packet) to the other satellite station 40.

The satellite station 40 according to the present embodiment can transfer the packet to a destination ground station 30D without recognizing network topology (network configuration) of the satellite communication system S. As described above, the satellite communication system S does not need to include a device that manages the network configuration, and can more easily determine an appropriate communication path.

Note that although the satellite communication system S transfers the packet via the two satellite stations 40_1 and 40_2 in the example of FIG. 4, the number of satellite stations 40 used for packet transfer is not limited to two. The satellite communication system S may transfer the packets via one satellite station 40 or may transfer the packet via two or more satellite stations 40.

### 1.3. Device Configuration Example

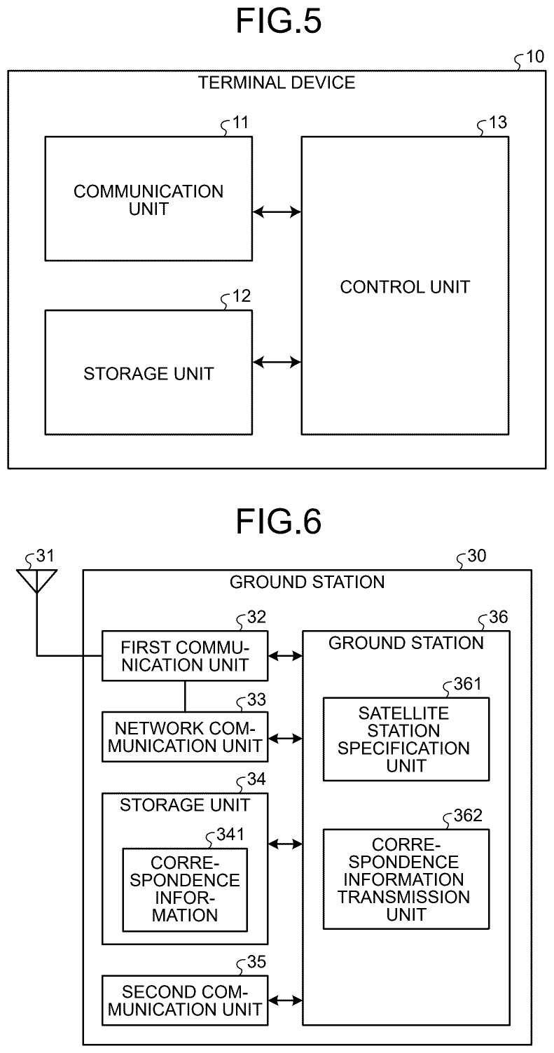

Next, a configuration example of each device included in the satellite communication system S according to the present embodiment will be described with reference to FIG. 5 to FIG. 7.

### 1.3.1. Terminal Device

FIG. 5 is a block diagram illustrating a configuration example of the terminal device 10 according to the first embodiment of the present disclosure. The terminal device 10 is a communication device that communicates with other devices (such as the ground station 30, another terminal device 10, and the like). The terminal device 10 is a kind of information processing device.

The terminal device 10 includes a communication unit 11, a storage unit 12, and a control unit 13. Note that the configuration illustrated in FIG. 5 is a functional configuration, and a hardware configuration may be different therefrom. Furthermore, functions of the terminal device 10 may be implemented in a manner of being distributed in a plurality of physically-separated configurations.

The communication unit 11 is a communication interface for communicating with a communication device (such as the ground station 30). The communication unit 11 may be a network interface or a device connection interface. The communication unit 11 may be a local area network (LAN) interface such as a network interface card (NIC), or may be a USB interface including a universal serial bus (USB) host controller, a USB port, or the like. The communication unit 11 may be a wired interface or a wireless interface. The communication unit 11 functions as a communication means of the terminal device 10. The communication unit 11 is controlled by the control unit 13.

The storage unit 12 is a data readable/writable storage device such as a dynamic random access memory (DRAM), a static random access memory (SRAM), a flash memory, or a hard disk. The storage unit 12 functions as a storage means of the terminal device 10.

The control unit 13 is a controller that controls each unit of the terminal device 10. The control unit 13 is realized by, for example, a processor such as a central processing unit (CPU) or micro processing unit (MPU). For example, the control unit 13 is realized by the processor executing various programs, which are stored in the storage device inside the terminal device 10, by using a random access memory (RAM) or the like as a work area. Note that the control unit 13 may be realized by an integrated circuit such as an application specific integrated circuit (ASIC) or a field programmable gate array (FPGA). Each of the CPU, MPU, ASIC, and FPGA can be regarded as a controller.

### 1.3.2. Ground Station

FIG. 6 is a block diagram illustrating a configuration example of the ground station 30 according to the first embodiment of the present disclosure. The ground station 30 is a communication device that communicates with other devices (such as the terminal device 10, the satellite station 40, and the like). The ground station 30 is a kind of information processing device. The ground station 30 has a function as a router that performs routing of data (packet) received from the network 20.

The ground station 30 includes an antenna unit 31, a first communication unit 32, a network communication unit 33, a storage unit 34, a second communication unit 35, and a control unit 36. Note that the configuration illustrated in FIG. 6 is a functional configuration, and a hardware configuration may be different therefrom. Furthermore, functions of the ground station 30 may be implemented in a manner of being distributed in a plurality of physically-separated configurations.

The antenna unit 31 radiates a signal output from the first communication unit 32 into a space as a laser. Furthermore, the antenna unit 31 converts the laser, which is transmitted from the satellite station 40, into a signal and outputs the signal to the first communication unit 32.

The first communication unit 32 transmits and receives signals. For example, the first communication unit 32 transmits a signal to the satellite station 40 and receives a signal from the satellite station 40. The first communication unit 32 operates under the control of the control unit 36.

The network communication unit 33 transmits and receives information. For example, the network communication unit 33 transmits information to the terminal device 10 and receives information from the terminal device 10. The network communication unit 33 communicates with other devices via the network 20 under the control of the control unit 36.

The storage unit 34 is a data readable/writable storage device such as a DRAM, an SRAM, a flash memory, or a hard disk. The storage unit 34 functions as a storage means of the ground station 30. A storage unit 43 stores correspondence information 341 in which, for example, the ground station 30 and a position of the ground station 30 are associated with each other.

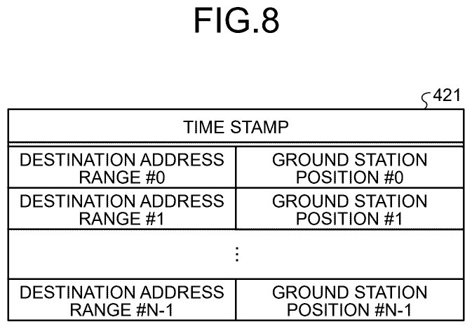

The correspondence information 341 (see FIG. 8) is information in which a destination of the data received by the satellite station 40 is associated with the position of the ground station 30. The correspondence information 341 is managed by, for example, the ground station 30. The ground station 30 generates/updates the correspondence information 341 according to, for example, addition of a new satellite station 40, the latest state (such as a communicable state, a non-communicable state due to a failure or the like, and the like) of the satellite station 40, and the like.

As described above, the data (packet) transmitted by the transmission source terminal device 10 is transmitted to the satellite station 40 via the ground station 30. The ground station 30 that transmits data to the satellite station 40 is also referred to as a transmission source ground station 30T. Furthermore, the data is transmitted from the satellite station 40 to the ground station 30 and transmitted to the destination terminal device 10. The ground station 30 that receives the data from the satellite station 40 is also referred to as a destination ground station 30D. The destination ground station 30D is specified from a destination address included in the data. For example, data whose destination address is in a predetermined range (destination address range) is transmitted to a predetermined ground station 30.

The correspondence information 341 includes, for example, the destination address range as destination ground station information that specifies the destination ground station 30D. Furthermore, the correspondence information 341 includes ground station position information including, for example, latitude and longitude as a position of the destination ground station 30D.

The second communication unit 35 illustrated in FIG. 6 performs wireless communication (second communication) using a beacon, for example. The second communication unit 35 transmits a beacon signal to the satellite station 40. The second communication unit 35 receives a beacon signal from the satellite station 40.

For example, the second communication unit 35 transmits a beacon by using a laser. Alternatively, the second communication unit 35 transmits a beacon by using a radio frequency (such as an RF frequency). In this case, the beacon is an RF signal.

The control unit 36 is a controller that controls each unit of the ground station 30. The control unit 36 is realized by, for example, a processor such as a CPU or an MPU. For example, the control unit 36 is realized by the processor executing various programs stored in a storage device inside the ground station 30 with a RAM or the like as a work area. Note that the control unit 36 may be realized by an integrated circuit such as an ASIC or FPGA. Each of the CPU, MPU, ASIC, and FPGA can be regarded as a controller.

The control unit 36 illustrated in FIG. 6 includes a satellite station specification unit 361 and a correspondence information transmission unit 362. Each block (satellite station specification unit 361 and correspondence information transmission unit 362) included in the control unit 36 is a functional block indicating a function of the control unit 36. These functional blocks may be software blocks or hardware blocks. For example, each of the above-described functional blocks may be one software module realized by software (including a microprogram), or may be one circuit block on a semiconductor chip (die). Obviously, each of the functional blocks may be one processor or one integrated circuit. A configuration method of the functional blocks is arbitrary. Note that the control unit 36 may be configured in units of functions different from the above-described functional blocks.

The satellite station specification unit 361 specifies a destination satellite station 40D, to which the correspondence information 341 is transmitted, by using the second communication unit 35. The satellite station specification unit 361 controls a second communication unit 45 to transmit a beacon, for example. When the second communication unit 35 receives a reply to the beacon, the satellite station specification unit 361 determines that the second communication using the beacon is performed with the satellite station 40 that makes the reply.

In addition, from an arrival direction of the beacon, the satellite station specification unit 361 detects a direction in which the satellite station 40 is present. The satellite station specification unit 361 adjusts a direction of the antenna unit 31 of the own station in the detected direction in such a manner that the first communication with the satellite station 40 can be performed. In addition, the satellite station specification unit 361 acquires information indicating whether an antenna unit 41 is adjusted by the satellite station 40 to face the direction of the own station.

Since the direction of the antenna unit 31 of the own station is adjusted and the direction of the antenna unit 41 of the satellite station 40 is adjusted, the ground station 30 can perform the first communication with the satellite station 40. The satellite station specification unit 361 sets the satellite station 40 capable of performing the first communication with the own station as the destination satellite station 40D.

That is, the satellite station specification unit 361 determines that the destination satellite station 40D is found (specified) in a case where the first communication with the satellite station 40 becomes possible by performance of the second communication using the beacon.

For example, in a case where the second communication unit 35 transmits the beacon by using the laser, the satellite station specification unit 361 may transmit a plurality of the beacons within a predetermined range. The laser has high directivity. Thus, when the satellite station specification unit 361 transmits the beacons in the predetermined range, it becomes easy to find the destination satellite station 40D that can communicate with the ground station 30.

On the other hand, in a case where the second communication unit 35 transmits the beacon by using the RF signal, the satellite station specification unit 361 may transmit the beacon in a predetermined direction. The RF signal is less directional compared to the laser. Thus, the satellite station specification unit 361 can search for the destination satellite station 40D in a wide range by one beacon transmission as compared with the laser.

The correspondence information transmission unit 362 transmits the correspondence information 341 to the destination satellite station 40D specified by the satellite station specification unit 361. The correspondence information transmission unit 362 transmits the correspondence information 341 via the first communication unit 32. For example, the correspondence information transmission unit 362 may transmit the correspondence information 341 including time at which the correspondence information 341 is transmitted as a time stamp.

Note that although the configuration example of the ground station 30 that transmits the correspondence information 341 has been described here, not all the ground stations 30 need to transmit the correspondence information 341 to the satellite station 40. For example, some of the ground stations 30 such as the ground station 30 installed in a place in which management is difficult and the ground station 30 with strict power limitation may not transmit the correspondence information 341.

In such a manner, in the ground station 30 that does not transmit the correspondence information 341, components related to the transmission of the correspondence information 341 (such as the second communication unit 35, the satellite station specification unit 361, the correspondence information transmitting unit 362, and the like) may be omitted.

### 1.3.3. Satellite Station

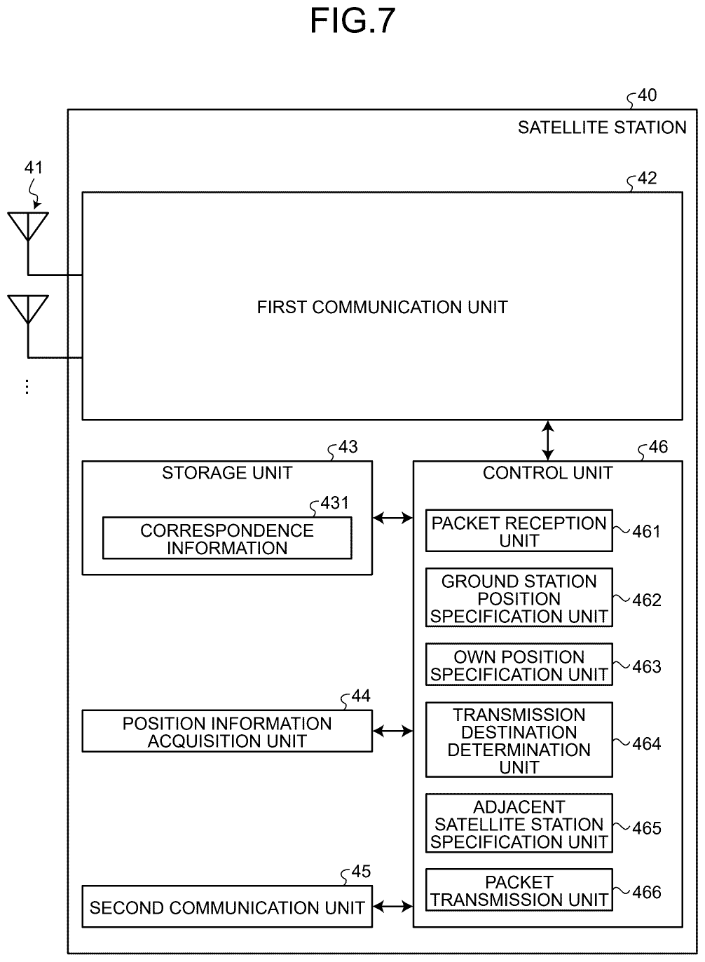

FIG. 7 is a block diagram illustrating a configuration example of the satellite station 40 according to the first embodiment of the present disclosure. The satellite station 40 is a communication device that communicates with other devices (such as the ground station 30, another satellite station 40, and the like). The satellite station 40 has a function as a router that performs routing of data (packet) received from the ground station 30.

The satellite station 40 includes the antenna unit 41, a first communication unit 42, a storage unit 43, a position information acquisition unit 44, a second communication unit 45, and a control unit 46. Note that the configuration illustrated in FIG. 7 is a functional configuration, and a hardware configuration may be different therefrom. Furthermore, functions of the satellite station 40 may be implemented in a manner of being distributed in a plurality of physically-separated configurations.

The antenna unit 41 radiates a signal, which is output from the first communication unit 42, into space as a laser. Furthermore, the antenna unit 41 converts a laser transmitted by the ground station 30 or another satellite station 40 into a signal, and outputs the signal to the first communication unit 42.

The first communication unit 42 performs first communication using a packet. The first communication unit 42 transmits and receives a signal (packet). For example, the first communication unit 42 transmits a signal to the ground station 30 or the other satellite station 40, and receives a signal from the ground station 30 or the other satellite station 40. The first communication unit 42 operates under the control of the control unit 46.

Note that the satellite station 40 may include a plurality of the antenna units 41 and a plurality of the first communication units 42. For example, the antenna unit 41 and the first communication unit 42 that perform wireless communication with the ground station 30 may be different from the antenna unit 41 and the first communication unit 42 that perform wireless communication with the other satellite station 40.

The storage unit 43 is a data readable/writable storage device such as a DRAM, an SRAM, a flash memory, or a hard disk. The storage unit 43 functions as a storage means of the ground station 30.

The storage unit 43 stores correspondence information 431 in which, for example, a destination address of the packet and a position of the ground station 30 are associated with each other. For example, the satellite station 40 acquires the correspondence information 431 from the ground station 30 and stores the correspondence information in the storage unit 43.

FIG. 8 is a table illustrating an example of the correspondence information 431 stored in the satellite station 40 according to the first embodiment of the present disclosure. As illustrated in FIG. 8, the correspondence information 431 includes a “time stamp”, a “destination address range”, and a “ground station position”.

The “time stamp” is information indicating the time at which the ground station 30 transmits the correspondence information 431. For example, in a case of receiving the correspondence information 431 from the ground station 30, the satellite station 40 stores, in the storage unit 43, the correspondence information 431 in which the time indicated by the “time stamp” is the latest.

In FIG. 8, as the “destination address range”, N destination address ranges (destination address ranges #0 to #N−1) are included in the correspondence information 431. The satellite station 40 determines whether a destination address of the received data is included in any of the destination address ranges #0 to #N−1, and determines the destination ground station 30D of the received data.

In FIG. 8, as the “ground station position” corresponding to the “destination address range,” N ground station positions (ground station positions #0 to #N−1) are included in the correspondence information 431. The satellite station 40 determines (specifies) the position of the destination ground station 30D by determining whether the destination address of the received data is included in any of the destination address ranges #0 to #N−1.

Returning to FIG. 7, the position information acquisition unit 44 acquires position information of the satellite station 40. The position information acquisition unit 44 is, for example, a global navigation satellite system (GNSS) receiver. The position information acquisition unit 44 acquires the position information of the satellite station 40 by receiving a GNSS signal.

The second communication unit 45 performs wireless communication (second communication) using a beacon, for example. The second communication unit 45 transmits a beacon signal to another satellite station 40. The second communication unit 45 receives a beacon signal from the other satellite station 40.

For example, the second communication unit 45 transmits a beacon by using a laser. Alternatively, the second communication unit 45 transmits a beacon by using a radio frequency (such as an RF frequency). In this case, the beacon is an RF signal.

The control unit 46 is a controller that controls each unit of the satellite station 40. The control unit 46 is realized by, for example, a processor such as a CPU or an MPU. For example, the control unit 46 is realized by a processor executing various programs stored in a storage device inside the satellite station 40 with a RAM or the like as a work area. Note that the control unit 46 may be realized by an integrated circuit such as an ASIC or FPGA. Each of the CPU, MPU, ASIC, and FPGA can be regarded as a controller.

The control unit 46 illustrated in FIG. 7 includes a packet reception unit 461, a ground station specification unit 462, an own position specification unit 463, a transmission destination determination unit 464, an adjacent satellite station specification unit 465, and a packet transmission unit 466. Each of the blocks (packet reception unit 461 to packet transmission unit 466) included in the control unit 46 is a functional block indicating a function of the control unit 46. These functional blocks may be software blocks or hardware blocks. For example, each of the above-described functional blocks may be one software module realized by software (including a microprogram), or may be one circuit block on a semiconductor chip (die). Obviously, each of the functional blocks may be one processor or one integrated circuit. A configuration method of the functional blocks is arbitrary. Note that the control unit 46 may be configured in units of functions different from the above-described functional blocks.

The packet reception unit 461 receives a packet from the ground station 30 or the other satellite station 40 via the first communication unit 42. The packet reception unit 461 outputs the received packet to the ground station specification unit 462.

The ground station specification unit 462 acquires a destination address from the packet received by the packet reception unit 461 (reception packet). The ground station specification unit 462 specifies the position of the destination ground station 30D from the destination address on the basis of the correspondence information 431. The ground station specification unit 462 outputs the ground station position information related to the specified position of the destination ground station 30D to the transmission destination determination unit 464.

The own position specification unit 463 specifies a position of the own satellite station (own position) from the position information acquired by the position information acquisition unit 44. The own position specification unit 463 outputs the own position information related to the specified own position to the transmission destination determination unit 464.

The transmission destination determination unit 464 determines a transmission destination (transfer destination) of the reception packet according to the own position and the position of the destination ground station 30D. For example, in a case where the own satellite station can directly communicate with the destination ground station 30D, in other words, the destination ground station 30D is located in the cell of the own satellite station, the transmission destination determination unit 464 determines the transmission destination of the reception packet as the destination ground station 30D. In this case, the transmission destination determination unit 464 instructs the packet transmission unit 466 to transmit the reception packet to the destination ground station 30D.

On the other hand, in a case where the own satellite station cannot directly communicate with the destination ground station 30D, in other words, in a case where the destination ground station 30D is not located in the cell of the own satellite station, the transmission destination determination unit 464 determines another satellite station 40 (hereinafter, also referred to as an adjacent satellite station 40N) present around the own satellite station as the transmission destination of the reception packet. In this case, the transmission destination determination unit 464 instructs the adjacent satellite station specification unit 465 to specify the adjacent satellite station 40N.

The adjacent satellite station specification unit 465 specifies the adjacent satellite station 40N by using the second communication unit 45. For example, the adjacent satellite station specification unit 465 specifies the adjacent satellite station 40N located at a place closer to the destination ground station 30D than the own position according to the own position and the position of the destination ground station 30D.

The adjacent satellite station specification unit 465 controls the second communication unit 45 to transmit a beacon in a direction (direction) in which the destination ground station 30D is present, for example.

When the second communication unit 45 receives a reply to the beacon, the adjacent satellite station specification unit 465 determines that the second communication using the beacon with the satellite station 40 that makes the reply (hereinafter, described as a reply source satellite station 40RP) is performed.

In addition, the adjacent satellite station specification unit 465 detects a direction in which the reply source satellite station 40RP is present from an arrival direction of the beacon. The adjacent satellite station specification unit 465 adjusts the direction of the antenna unit 41 of the own satellite station in the detected direction in such a manner that the first communication with the reply source satellite station 40RP can be performed. Furthermore, the adjacent satellite station specification unit 465 acquires information indicating whether the antenna unit 41 is adjusted by the reply source satellite station 40RP to face a direction of the own satellite station.

Since the direction of the antenna unit 41 of the own satellite station is adjusted and the direction of the antenna unit 41 of the reply source satellite station 40RP is adjusted, the satellite station 40 can perform the first communication with the reply source satellite station 40RP. The adjacent satellite station specification unit 465 sets, as the adjacent satellite station 40N, the reply source satellite station 40RP that can perform the first communication with the own satellite station.

That is, in a case where it becomes possible to perform the first communication with the other satellite station 40 by performing the second communication using the beacon, the adjacent satellite station specification unit 465 determines that the adjacent satellite station 40N (other satellite station 40) is found (specified).

For example, in a case where the position of the satellite station 40 that makes the reply is closer to the destination ground station 30D than the own position, the adjacent satellite station specification unit 465 determines the satellite station 40 as the transmission destination of the reception packet (adjacent satellite station 40N).

For example, in a case where the second communication unit 45 transmits a beacon by using a laser, the adjacent satellite station specification unit 465 may transmit a plurality of the beacons in a predetermined range including the direction in which the destination ground station 30D is present. The laser has high directivity. Thus, when the adjacent satellite station specification unit 465 transmits the beacons within the predetermined range, it becomes easier to find the adjacent satellite station 40N that can communicate with the destination ground station 30D.

On the other hand, in a case where the second communication unit 45 transmits the beacon by using the RF signal, the adjacent satellite station specification unit 465 may transmit the beacon in the direction (direction) in which the destination ground station 30D is present. The RF signal is less directional compared to the laser. Thus, the adjacent satellite station specification unit 465 can search for the adjacent satellite station 40N in a wide range by one beacon transmission as compared with the laser.

The adjacent satellite station specification unit 465 outputs adjacent satellite station information related to the specified adjacent satellite station 40N to the packet transmission unit 466.

The packet transmission unit 466 transmits the reception packet to the destination ground station 30D or the adjacent satellite station 40N. In a case of being instructed by the transmission destination determination unit 464 to transmit the packet to the destination ground station 30D, the packet transmission unit 466 transfers the reception packet to the destination ground station 30D via the first communication unit 42.

For example, in a case where the second communication unit 45 transmits the beacon by using the laser, the packet transmission unit 466 controls the first communication unit 42 to transmit the packet in the same direction as the direction in which the second communication unit 45 performs the transmission.

On the other hand, in a case where the second communication unit 45 transmits the beacon by using the RF signal, the packet transmission unit 466 transmits the packet in a direction based on the position of the adjacent satellite station 40N (hereinafter, adjacent satellite position) which position is acquired from the adjacent satellite station 40N.

In a case of acquiring the adjacent satellite station information from the adjacent satellite station specification unit 465, the packet transmission unit 466 transfers the reception packet to the adjacent satellite station 40N on the basis of the adjacent satellite station information.

### 1.4. Example of Communication Processing

### 1.4.1. Packet Transfer Processing

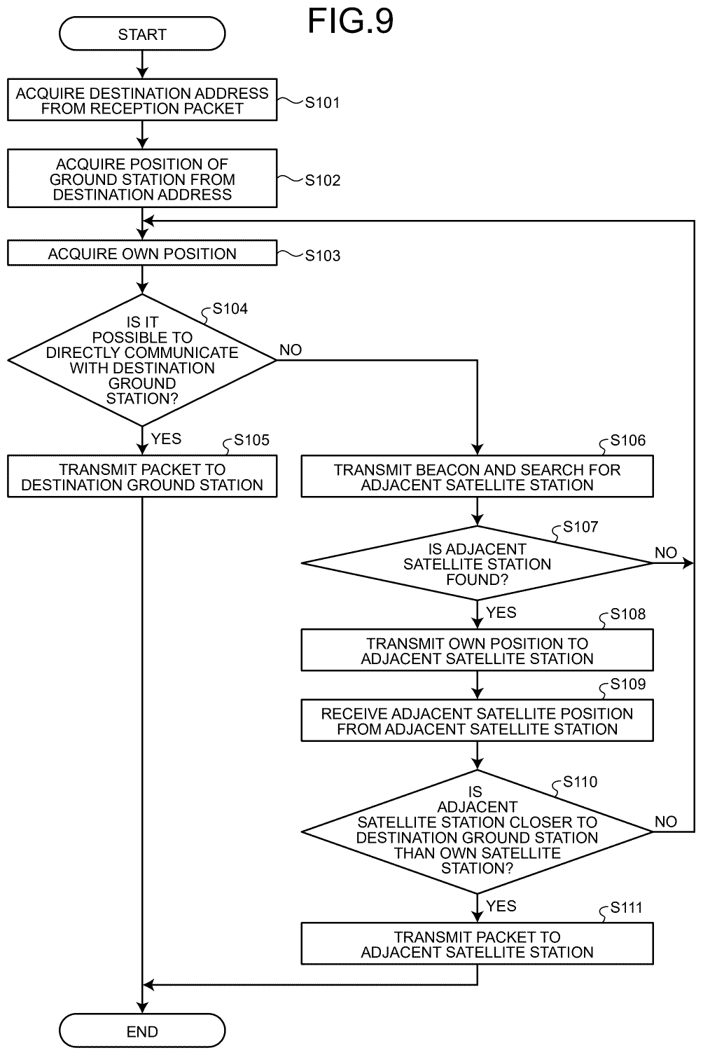

FIG. 9 is a flowchart illustrating an example of a flow of packet transfer processing according to the first embodiment of the present disclosure. The packet transfer processing in FIG. 9 is executed by the satellite station 40 when a packet is received.

First, the satellite station 40 acquires a destination address from the received packet (reception packet) (Step S101). Then, the satellite station 40 acquires a position of the ground station 30 corresponding to the destination address on the basis of the correspondence information 431 (Step S102). The satellite station 40 acquires a position of the destination ground station 30D according to which destination address range includes the destination address.

The satellite station 40 acquires the own position (Step S103). For example, the satellite station 40 acquires the position of the satellite station 40 (own position) from the position information acquisition unit 44.

The satellite station 40 determines whether direct communication with the destination ground station 30D can be performed from the own position and the position of the destination ground station 30D (Step S104).

In a case where direct communication with the destination ground station 30D can be performed (Step S104; Yes), the satellite station 40 transmits the packet to the destination ground station 30D (Step S105).

In a case where direct communication with the destination ground station 30D cannot be performed (Step S104; No), the satellite station 40 transmits a beacon and searches for the adjacent satellite station 40N (Step S106). Here, the satellite station 40 transmits the beacon in a direction (direction) of the destination ground station 30D on the basis of the own position and the position of the destination ground station 30D.

The satellite station 40 that transmits the beacon determines whether the adjacent satellite station 40N is found (Step S107). For example, the satellite station 40 determines that the adjacent satellite station 40N is found in a case where the beacon from the adjacent satellite station 40N is received and the directions of the antenna units 41 of the both are adjusted in such a manner that the first communication can be performed. The beacon received from the adjacent satellite station 40N (reception beacon) is a reply to the beacon transmitted by the satellite station 40 (transmission beacon).

In a case where the adjacent satellite station 40N is not found (Step S107; No), the satellite station 40 returns to Step S103 and acquires the own position.

In a case where the adjacent satellite station 40N is found (Step S107; Yes), the satellite station 40 transmits the own position to the adjacent satellite station 40N (Step S108), and receives the position of the adjacent satellite station 40N (adjacent satellite position) from the adjacent satellite station 40N (Step S109).

The satellite station 40 determines whether the adjacent satellite station 40N is closer to the destination ground station 30D than the own satellite station on the basis of the adjacent satellite position and the own position (Step S110).

In a case where the own satellite station is closer to the destination ground station 30D than the adjacent satellite station 40N (Step S110; No), the satellite station 40 returns to Step S103 and acquires the own position.

On the other hand, in a case where the adjacent satellite station 40N is closer to the destination ground station 30D than the own satellite station (Step S110; Yes), the satellite station 40 transmits (transfers) the packet to the adjacent satellite station 40N (Step S111).

### 1.4.2. Correspondence Information Transmission Processing

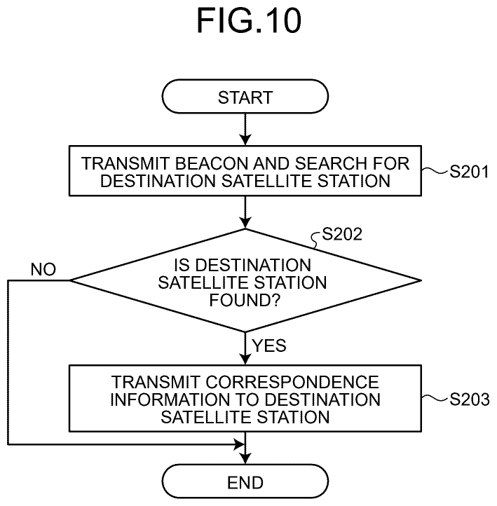

FIG. 10 is a flowchart illustrating an example of a flow of correspondence information transmission processing according to the first embodiment of the present disclosure. The correspondence information transmission processing in FIG. 10 is executed by the ground station 30 at a constant cycle.

As illustrated in FIG. 10, the ground station 30 first transmits a beacon and searches for the destination satellite station 40D to which the correspondence information 341 is transmitted (Step S201).

The ground station 30 that transmits the beacon determines whether the destination satellite station 40D is found (Step S202). For example, the ground station 30 determines that the destination satellite station 40D is found in a case where the beacon is received from the destination satellite station 40D and the directions of the antenna units 31 and 41 of the both are adjusted in such a manner that the first communication can be performed. The beacon received from the destination satellite station 40D (reception beacon) is a reply to the beacon transmitted by the satellite station 40 (transmission beacon).

In a case where the destination satellite station 40D is not found (Step S202; No), the ground station 30 ends the processing.

In a case where the destination satellite station 40D is found (Step S202; Yes), the ground station 30 transmits the correspondence information 341 to the destination satellite station 40D (Step S3203).

As described above, in the satellite communication system S according to the first embodiment of the present disclosure, the satellite station 40 that receives the packet transfers the packet to the destination ground station 30D or the adjacent satellite station 40N closer to the destination ground station 30D than the own satellite station. By repetition of the transfer of the packet between the satellite stations 40, the packet reaches the satellite station 40 capable of directly communicating with the destination ground station 30D.

As a result, the satellite communication system S can perform communication between the terminal devices 10 via the satellite stations 40 without grasping the network configuration. In such a manner, the satellite communication system S can more easily determine the communication path between the terminal devices 10.

In addition, in the present embodiment, the first communication unit 42 performs spatial optical communication using the laser. As described above, since the laser has high directivity, it is difficult to establish a link (such as a link between the satellite stations 40 or between the satellite station 40 and the ground station 30) in the spatial optical communication. Thus, in a case where communication between the satellite stations 40 is planned in advance, there is a possibility that the satellite stations 40 cannot perform the communication as planned.

On the other hand, in the present embodiment, after receiving the packet, the satellite station 40 dynamically searches for the adjacent satellite station 40N capable of performing communication and transfers the packet. Thus, even in a case where the first communication unit 42 performs the spatial optical communication, the satellite station 40 can establish a link more reliably (with a high probability), and can transfer a packet to the adjacent satellite station 40N more reliably (with a high probability).

### 2. SECOND EMBODIMENT

Although the satellite station 40 searches for the adjacent satellite station 40N after receiving the packet in the first embodiment described above, the satellite station 40 may search for the adjacent satellite station 40N in advance.

### 2.1. Configuration Example of a Satellite Station

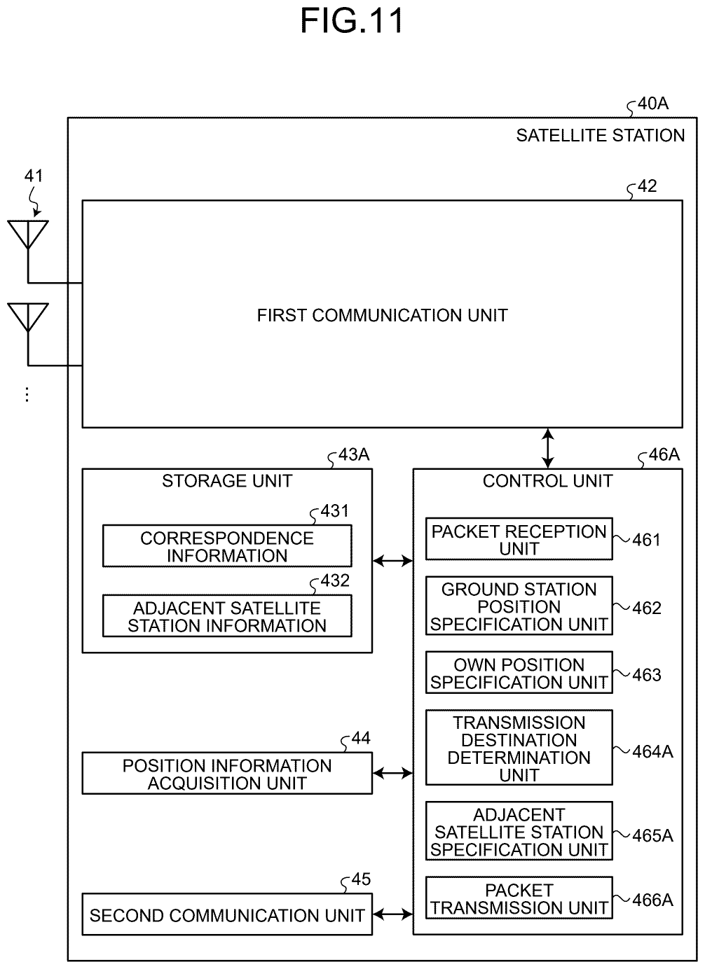

FIG. 11 is a block diagram illustrating a configuration example of a satellite station 40A according to the second embodiment of the present disclosure.

A storage unit 43A of the satellite station 40A illustrated in FIG. 11 stores adjacent satellite station information 432.

In addition, an adjacent satellite station specification unit 465A of a control unit 46A searches for an adjacent satellite station 40N in advance, and stores a result of the search in the storage unit 43A as adjacent satellite station information 432. The adjacent satellite station specification unit 465A controls a second communication unit 45 to transmit a beacon to a periphery of the own satellite station. When the second communication unit 45 receives a reply to the beacon, the adjacent satellite station specification unit 465A determines that second communication using the beacon with a satellite station 40 that makes the reply is performed, and sets the satellite station 40 as the adjacent satellite station 40N.

The adjacent satellite station specification unit 465A acquires an adjacent satellite position from the adjacent satellite station 40N. The adjacent satellite station specification unit 465A associates the acquired adjacent satellite position with information for identifying the adjacent satellite station 40N, and performs storing thereof into the storage unit 43 as adjacent satellite station information 432.

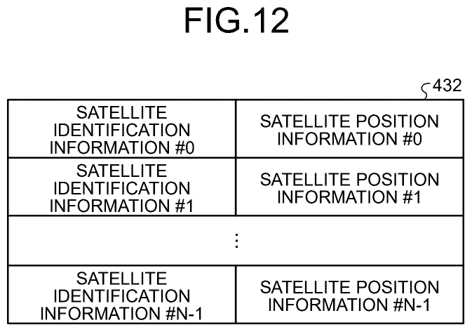

FIG. 12 is a table illustrating an example of the adjacent satellite station information 432 according to the second embodiment of the present disclosure. The adjacent satellite station information 432 includes the information for identifying the satellite station 40 (satellite identification information) and the information related to the position of the satellite station 40 (satellite position information). In FIG. 12, the adjacent satellite station information 432 includes information related to N adjacent satellite stations 40N.

Note that the adjacent satellite station information 432 illustrated in FIG. 12 is an example. For example, the adjacent satellite station information 432 may include information other than the satellite identification information and the satellite position information. For example, the adjacent satellite station information 432 may include time information related to the time at which the satellite position information is acquired.

In this case, the satellite station 40A may discard the adjacent satellite station information 432 for which a certain period elapses. This is because there is a possibility that the adjacent satellite station 40N is not present at the acquired satellite position after the certain period since the satellite station 40 is moving as described above.

Returning to FIG. 11, a transmission destination determination unit 464A of the control unit 46A determines a transmission destination (transfer destination) of a reception packet according to an own position and a position of a destination ground station 30D.

For example, in a case where the satellite station 40A can directly communicate with the destination ground station 30D, in other words, the destination ground station 30D is located in a cell of the satellite station 40A, the transmission destination determination unit 464A determines the transmission destination of the reception packet as the destination ground station 30D. In this case, the transmission destination determination unit 464A instructs a packet transmission unit 466A to transmit the reception packet to the destination ground station 30D.

On the other hand, in a case where the satellite station 40A cannot directly communicate with the destination ground station 30D, in other words, in a case where the destination ground station 30D is not located in the cell of the satellite station 40A, the transmission destination determination unit 464A determines an adjacent satellite station 40N present around the satellite station 40A as the transmission destination of the reception packet.

In this case, the transmission destination determination unit 464A selects a transmission destination satellite station 40R from the adjacent satellite stations 40N included in the adjacent satellite station information 432 stored in the storage unit 43A. For example, the transmission destination determination unit 464A selects, as the transmission destination satellite station 40R, the adjacent satellite station 40N closer to the destination ground station 30D than the own position.

For example, the transmission destination determination unit 464A selects the adjacent satellite station 40N in a direction of the destination ground station 30D. In a case where the selected adjacent satellite station 40N is closer to the destination ground station 30D than the satellite station 40A, the transmission destination determination unit 464A selects the adjacent satellite station 40N as the transmission destination satellite station 40R.

In a case where there is a plurality of the adjacent satellite stations 40N closer to the destination ground station 30D than the own position, the transmission destination determination unit 464A selects, as the transmission destination satellite station 40R, the adjacent satellite station 40N having the latest time of acquisition of the adjacent satellite position, for example. Alternatively, the transmission destination determination unit 464A may select the adjacent satellite station 40N closest to the destination ground station 30D as the transmission destination satellite station 40R. Furthermore, the transmission destination determination unit 464A may select the adjacent satellite station 40N with which a link can be easily established as the transmission destination satellite station 40R. The ease of establishing the link is determined according to, for example, a direction of an antenna unit 41.

The transmission destination determination unit 464A instructs the packet transmission unit 466A to transmit the reception packet to the selected adjacent satellite station 40N.

The packet transmission unit 466A transfers the reception packet to the transmission destination (destination ground station 30D or transmission destination satellite station 40R) determined by the transmission destination determination unit 464A.

### 2.2. Example of Communication Processing

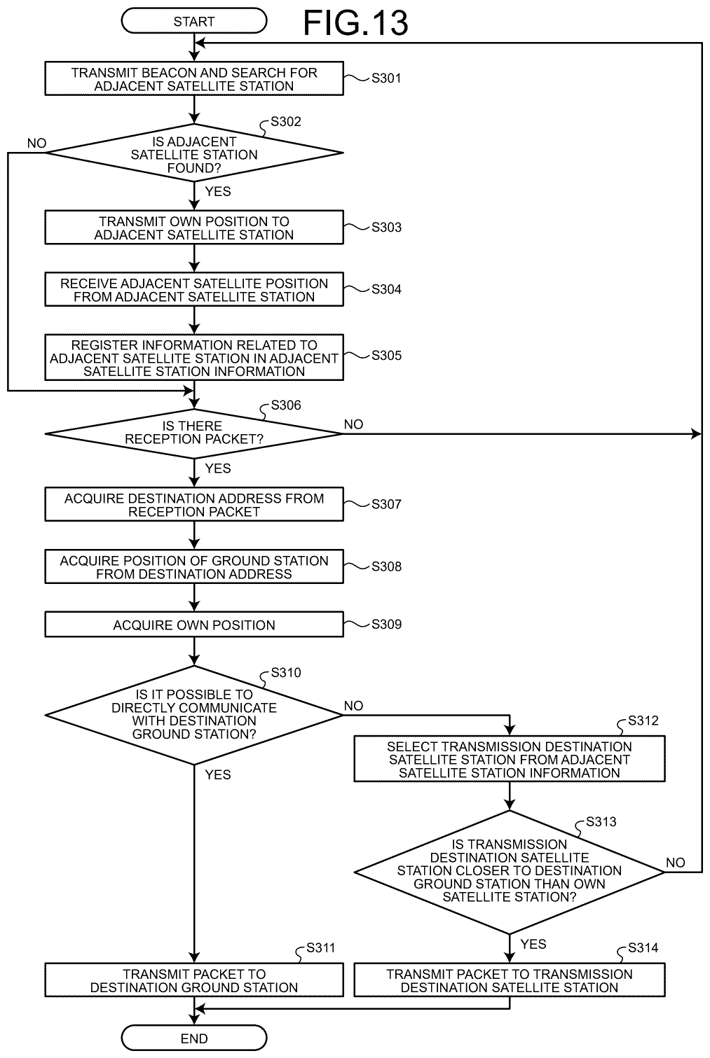

FIG. 13 is a flowchart illustrating an example of a flow of communication processing according to the second embodiment of the present disclosure. The communication processing in FIG. 13 is repeatedly executed by the satellite station 40A.

As illustrated in FIG. 13, the satellite station 40A transmits a beacon and searches for the adjacent satellite station 40N (Step S301). Here, the satellite station 40A transmits the beacon around the own satellite station without specifically limiting a direction.

The satellite station 40A that transmits the beacon determines whether the adjacent satellite station 40N is found (Step S302). For example, in a case of receiving a beacon from the adjacent satellite station 40N, the satellite station 40A determines that the adjacent satellite station 40N is found. The beacon received from the adjacent satellite station 40N (reception beacon) is a reply to the beacon transmitted by the satellite station 40A (transmission beacon).

In a case where the adjacent satellite station 40N is not found (Step S302; No), the satellite station 40A proceeds to Step S306.

In a case where the adjacent satellite station 40N is found (Step S302; Yes), the satellite station 40A transmits the own position to the adjacent satellite station 40N (Step S303), and receives the position of the adjacent satellite station 40N (adjacent satellite position) from the adjacent satellite station 40N (Step S304).

The satellite station 40A registers information related to the adjacent satellite station 40N (satellite identification information and satellite position information) in the adjacent satellite station information 432 (Step S305). For example, as the adjacent satellite station information 432, the satellite station 40A stores the satellite position information related to the adjacent satellite position in the storage unit 43 in association with the satellite identification information.

Then, the satellite station 40A determines whether there is a reception packet (Step S306). In a case of receiving the packet, the satellite station 40A determines that there is the reception packet. Alternatively, for example, as described later, in a case where the satellite station 40A includes a reception buffer, the satellite station 40A determines that there is the reception packet in a case where the reception packet is stored in the reception buffer.

In a case of determining that there is no reception packet (Step S306; No), the satellite station 40A returns to Step S301 and searches for the adjacent satellite station 40N.

In a case of determining that there is the reception packet (Step S306; Yes), the satellite station 40A acquires a destination address from the reception packet (Step S307). Then, the satellite station 40A acquires a position of a ground station 30 corresponding to the destination address on the basis of correspondence information (Step S308). The satellite station 40A acquires the position of the destination ground station 30D according to which destination address range includes the destination address.

The satellite station 40A acquires the own position (Step S309). For example, the satellite station 40A acquires the position of the satellite station 40A (own position) from a position information acquisition unit 44.

The satellite station 40A determines whether direct communication with the destination ground station 30D can be performed from the own position and the position of the destination ground station 30D (Step S310).

In a case where direct communication with the destination ground station 30D can be performed (Step S310; Yes), the satellite station 40A transmits a packet to the destination ground station 30D (Step S311).

In a case where direct communication with the destination ground station 30D cannot be performed (Step S310; No), the satellite station 40A selects the transmission destination satellite station 40R from the adjacent satellite station information 432 (Step S312).

The satellite station 40A determines whether the selected transmission destination satellite station 40R is closer to the destination ground station 30D than the own satellite station (Step S313).

In a case where the own satellite station is closer to the destination ground station 30D than the transmission destination satellite station 40R (Step S313; No), the satellite station 40A returns to Step S301 and searches for the adjacent satellite station 40N.

In a case where the transmission destination satellite station 40R is closer to the destination ground station 30D than the satellite station 40A (Step S313; Yes), the satellite station 40A transmits (transfers) the packet to the transmission destination satellite station 40R (Step S314).

As described above, the satellite station 40A according to the second embodiment of the present disclosure searches for surrounding adjacent satellite stations 40N in advance, and selects the transmission destination satellite station 40R from among the found adjacent satellite stations 40N in a case of transferring the reception packet. As a result, the satellite station 40A can transfer the packet earlier as compared with a case of searching for the transmission destination satellite station 40R after receiving the packet.

### 3. THIRD EMBODIMENT

The satellite station 40 of the first embodiment described above may include a reception buffer and a retry counter. Note that, here, although a case where the satellite station 40 according to the first embodiment includes the reception buffer and the retry counter will be described, the satellite station 40A according to the second embodiment may include the reception buffer and the retry counter.

### 3.1. Configuration Example of a Satellite Station

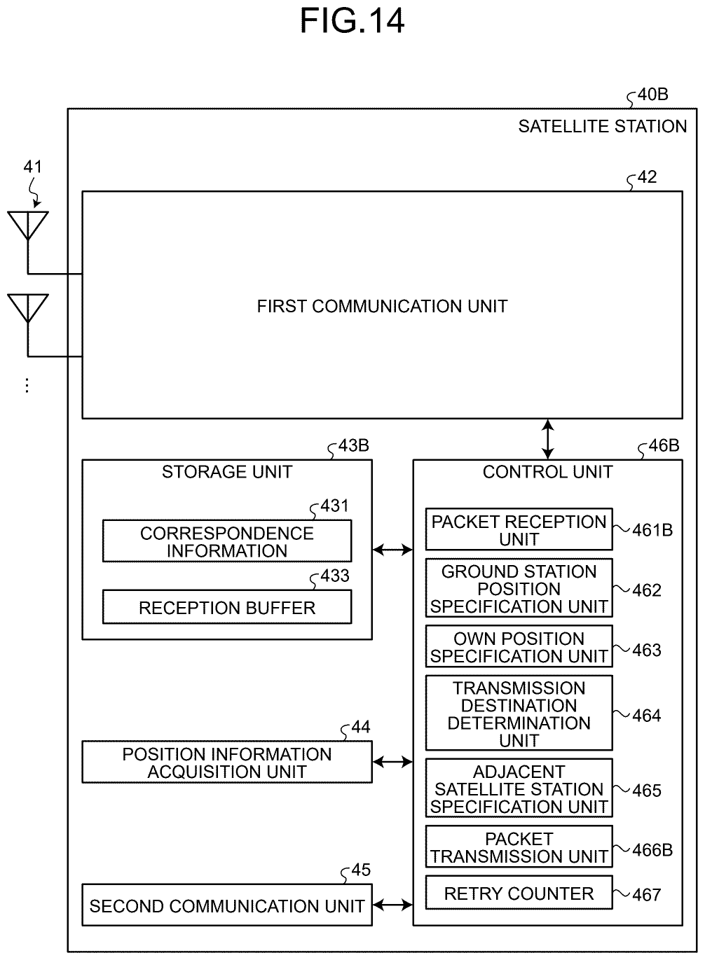

FIG. 14 is a block diagram illustrating a configuration example of a satellite station 40B according to the third embodiment of the present disclosure. A storage unit 43B of the satellite station 40B illustrated in FIG. 14 includes a reception buffer 433. Furthermore, a control unit 46B of the satellite station 40B includes a retry counter 467.

The reception buffer 433 holds a packet received by a first communication unit 42 (reception packet).

A packet reception unit 461B of the control unit 46B stores the received packet in the reception buffer 433. Note that it is assumed in the present embodiment that the packet reception unit 461B stores all the received packets in the reception buffer 433. A packet transmission unit 466B extracts the reception packets stored in the reception buffer 433 one by one and transmits (transfers) the packets.

The retry counter 467 counts the number of times the packet transmission unit 466B performs the packet transmission processing. The retry counter 467 counts the number of times the packet transmission unit 466B executes the packet transmission processing and fails to transmit the packet (the number of times of a search for an adjacent satellite station 40N).

The packet transmission unit 466B transmits the packet to a destination ground station 30D or a transmission destination satellite station 40R. The packet transmission unit 466B counts the number of times the packet cannot be transmitted to the transmission destination satellite station 40R by using the retry counter 467.

For example, in a case where the adjacent satellite station 40N cannot be found, the packet transmission unit 466B determines that the packet cannot be transmitted. For example, in a case where the satellite station 40B is closer to the destination ground station 30D than the adjacent satellite station 40N, the packet transmission unit 466B determines that the packet cannot be transmitted.

For example, in a case where the packet cannot be transmitted to the adjacent satellite station 40N, the packet transmission unit 466B determines that the packet cannot be transmitted. The packet transmission unit 466B determines whether the packet can be transmitted to the adjacent satellite station 40N on the basis of satellite related information related to the adjacent satellite station 40N. The satellite related information includes, for example, device information related to a state of each unit such as an antenna unit 41 of the adjacent satellite station 40N, buffer information related to a state (free state) of the reception buffer 433, and the like. The device information includes, for example, failure information related to a failure of the adjacent satellite station 40N.

For example, in a case where the adjacent satellite station 40N cannot perform communication due to a failure, the packet transmission unit 466B determines that the packet cannot be transmitted to the adjacent satellite station 40N. Alternatively, in a case where there is no free space in the reception buffer 433 of the adjacent satellite station 40N, the packet transmission unit 466B determines that the packet cannot be transmitted to the adjacent satellite station 40N.

Note that the packet transmission unit 466B acquires the satellite related information from the adjacent satellite station 40N via a second communication unit 45, for example. For example, the second communication unit 45 may acquire the satellite related information at the same time as acquisition of an adjacent satellite position.

For example, the packet transmission unit 466B counts the number of times of determination that the packet cannot be transmitted. In a case where the number of times of transmission failure exceeds a threshold Th, the packet transmission unit 466B stops the packet transmission. For example, the packet transmission unit 466B stops the packet transmission by discarding the packet.

Alternatively, the packet transmission unit 466B stores, into the reception buffer 433, the packet that cannot be transmitted, and performs transmission processing of another reception packet stored in the reception buffer 433. Note that the packet transmission unit 466B may perform transmission processing of the packet, which cannot be transmitted, again after transmitting the other reception packet.

The packet transmission unit 466B may store, in the reception buffer 433, the reception packet and the number of times the packet cannot be transmitted. In a case where the number of times of transmission failure exceeds a predetermined number of times, the packet transmission unit 466B may discard the packet. As a result, the satellite station 40B can use the reception buffer 433 more efficiently.

### 3.2. Example of Communication Processing

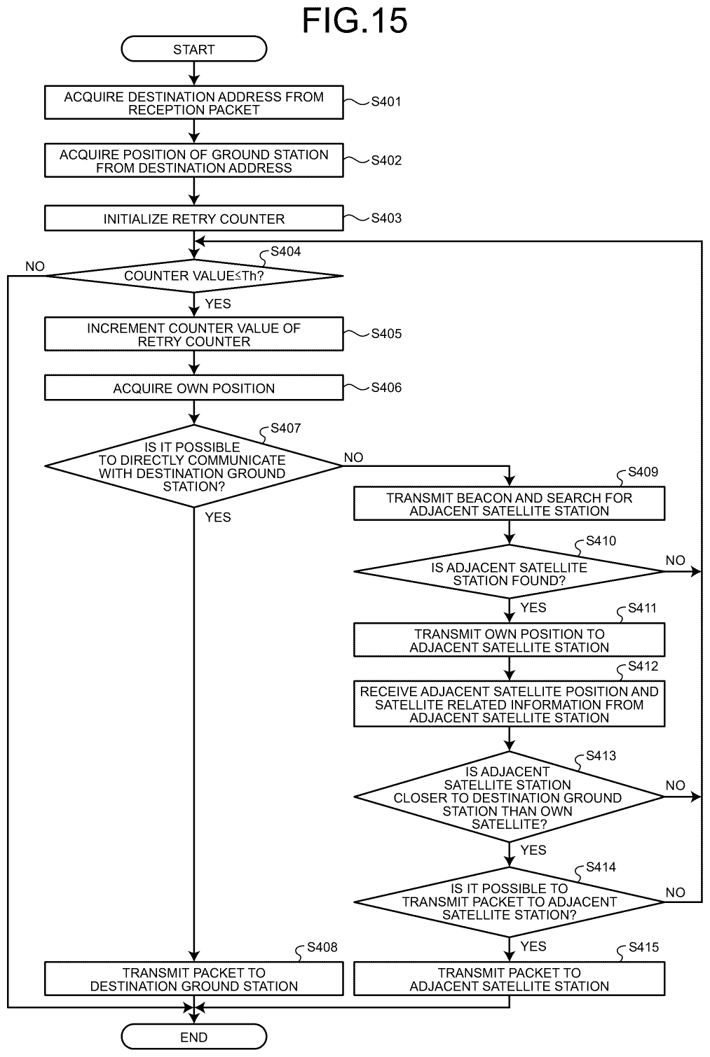

FIG. 15 is a flowchart illustrating an example of a flow of communication processing according to the third embodiment of the present disclosure. The communication processing illustrated in FIG. 15 is executed by the satellite station 40B in a case where a packet is received or in a case where a packet is stored in the reception buffer 433.

As illustrated in FIG. 15, the satellite station 40B acquires a destination address from the reception packet (Step S401). For example, the satellite station 40B extracts the reception packet from the reception buffer 433 and acquires the destination address from the extracted reception packet.

Then, the satellite station 40B acquires a position of a ground station 30 corresponding to the destination address on the basis of correspondence information (Step S402). The satellite station 40B acquires the position of the destination ground station 30D according to which destination address range includes the destination address.

The satellite station 40B initializes the retry counter 467 (Step S403). The satellite station 40B initializes the retry counter 467, for example, by setting the value of the retry counter 467 to zero.

The satellite station 40B determines whether a counter value of the retry counter 467 is equal to or smaller than the threshold Th (Step S404). In a case where the counter value is larger than the threshold Th (Step S404; No), the satellite station 40B ends the communication processing.

In a case where the counter value is equal to or smaller than the threshold Th (Step S404; Yes), the satellite station 40B increments the counter value of the retry counter 467 (Step S405). For example, the satellite station 40B increments the retry counter 467 by incrementing the counter value by “1”.

The satellite station 40B acquires the own position (Step S406). For example, the satellite station 40B acquires a position of the satellite station 40B (own position) from the position information acquisition unit 44.

The satellite station 40B determines whether direct communication with the destination ground station 30D can be performed from the own position and the position of the destination ground station 30D (Step S407).

In a case where direct communication with the destination ground station 30D can be performed (Step S407; Yes), the satellite station 40B transmits a packet to the destination ground station 30D (Step S408).

In a case where direct communication with the destination ground station 30D cannot be performed (Step S407; No), the satellite station 40B transmits a beacon and searches for the adjacent satellite station 40N (Step S409). Here, the satellite station 40B transmits the beacon in a direction (direction) of the destination ground station 30D on the basis of the own position and the position of the destination ground station 30D.

The satellite station 40B that transmits the beacon determines whether the adjacent satellite station 40N is found (Step S410). For example, in a case of receiving a beacon from the adjacent satellite station 40N, the satellite station 40B determines that the adjacent satellite station 40N is found. The beacon received from the adjacent satellite station 40N (reception beacon) is a reply to the beacon transmitted by the satellite station 40B (transmission beacon).

In a case where the adjacent satellite station 40N is not found (Step S410; No), the satellite station 40B returns to Step S404 and compares the counter value of the retry counter 467 with the threshold Th.

In a case where the adjacent satellite station 40N is found (Step S410; Yes), the satellite station 40B transmits the own position to the adjacent satellite station 40N (Step S411), and receives the position of the adjacent satellite station 40N (adjacent satellite position) and the satellite related information from the adjacent satellite station 40N (Step S412). Note that the adjacent satellite position and the satellite related information are also collectively referred to as satellite station information.

The satellite station 40B determines whether the adjacent satellite station 40N is closer to the destination ground station 30D than the own satellite station on the basis of the adjacent satellite position and the own position (Step S413).

In a case where the own satellite station is closer to the destination ground station 30D than the adjacent satellite station 40N (Step S413; No), the satellite station 40B returns to Step S404 and compares the counter value of the retry counter 467 with the threshold Th.

On the other hand, in a case where the adjacent satellite station 40N is closer to the destination ground station 30D than the own satellite station (Step S413; Yes), the satellite station 40B determines whether the packet can be transmitted to the adjacent satellite station 40N (Step S414). The satellite station 40B determines whether the packet can be transmitted according to whether the adjacent satellite station 40N is in failure, availability of the reception buffer of the adjacent satellite station 40N, and the like.

Note that the satellite related information may include information indicating whether the adjacent satellite station 40N can receive the packet. The satellite station 40B determines whether the packet can be transmitted according to a state (whether there is a failure, availability of the reception buffer 433, and the like) of the adjacent satellite station 40N. In this case, in a case where the adjacent satellite station 40N can receive the packet, the satellite station 40B determines that the packet can be transmitted.

In a case where the packet cannot be transmitted to the adjacent satellite station 40N (step S414; No), the satellite station 40B returns to Step S404 and compares the counter value of the retry counter 467 with the threshold Th.

In a case where the packet can be transmitted to the adjacent satellite station 40N (Step S414; Yes), the satellite station 40B transmits (transfers) the packet to the adjacent satellite station 40N (Step S415).

As described above, the satellite station 40B according to the third embodiment of the present disclosure includes the reception buffer 433 and the retry counter 467. As a result, the satellite station 40B can suspend the transmission processing (transfer processing) of the reception packet and start the transmission processing of the next reception packet. As a result, the satellite station 40B can prevent the transmission processing of the subsequent reception packet from being stopped due to inability to transfer the reception packet. That is, the satellite station 40B can transfer the reception packet more efficiently.

Furthermore, the satellite station 40B according to the present embodiment determines whether the packet can be transmitted on the basis of the satellite related information. As a result, the satellite station 40B can perform the packet transfer processing in accordance with the state of the adjacent satellite station 40N, and can transfer the packet more efficiently.

### 4. OTHER EMBODIMENTS

Each of the above-described embodiments is an example, and various modifications and applications are possible.

For example, although it has been described that the own position transmitted by the satellite station 40 to the adjacent satellite station 40N is the position information acquired by the position information acquisition unit 44 at the time of transmission (hereinafter, also referred to as current position information), the own position transmitted by the satellite station 40 is not limited thereto.

The own position may be position information acquired by the position information acquisition unit 44 at a time point before (a certain period before) the time of transmission (hereinafter, also referred to as past position information), or may be position information at a time point after (a certain period after) the time of transmission (hereinafter, also referred to as predicted position information). The position information at the time point after the time of transmission is, for example, a future own position predicted by the own position specification unit 463 on the basis of the orbit of the satellite station 40.

The own position transmitted from the satellite station 40 to the adjacent satellite station 40N may be position information at one time point or position information at a plurality of time points. For example, the satellite station 40 may transmit the past position information and the current position information to the adjacent satellite station 40N as the own position. Alternatively, the satellite station 40 may transmit the current position information and the predicted position information to the adjacent satellite station 40N as the own position.

Furthermore, the adjacent satellite station 40N may also transmit at least one of past position information, current position information, or predicted position information to the satellite station 40 as the adjacent satellite position, similarly to the own position of the satellite station 40.

For example, the satellite station 40 may determine whether the adjacent satellite station 40N is moving to approach the destination ground station 30D on the basis of the position information at a plurality of time points. The satellite station 40 transfers the reception packet to, for example, the adjacent satellite station 40N that is closer to the destination ground station 30D than the own satellite station and that further moves in the direction of the destination ground station 30D. Alternatively, on the basis of the predicted position information, the satellite station 40 transfers the reception packet to the adjacent satellite station 40N closer to the destination ground station 30D than the own satellite station 40 at a time point after the transmission.

As a result, the satellite station 40 can transfer the packet to the adjacent satellite station 40N in such a manner that the packet reaches the destination ground station 30D via a shorter path.

Furthermore, the satellite station 40 may determine whether the orbits of the own satellite station and the adjacent satellite station 40N are the same or different on the basis of the position information at a plurality of time points. For example, the satellite station 40 transfers the packet to the adjacent satellite station 40N according to whether a difference between the orbits of the own satellite station and the adjacent satellite station 40N is equal to or smaller than a predetermined value.

For each of the own satellite station and the adjacent satellite station 40N, the satellite station 40 calculates a vector (orbit vector) connecting positions at least at two time points. The satellite station 40 calculates an inner product of the calculated orbit vectors. In a case where the inner product is equal to or larger than a threshold, the satellite station 40 determines that the orbits of the own satellite station and the adjacent satellite station 40N are the same. In a case where the inner product is smaller than the threshold, the satellite station 40 determines that the orbits of the own satellite station and the adjacent satellite station 40N are different.

For example, in a case of determining that the orbit of the own satellite station is different from that of the adjacent satellite station 40N, the satellite station 40 stops the transfer of the packet to the adjacent satellite station 40N, and a search for another satellite station 40 is performed again.

The time in which the satellite stations 40 in different orbits can directly communicate with each other is limited. Furthermore, communication between the satellite stations 40 in different orbits is less reliable than communication between the satellite stations 40 in the same orbit. Thus, the satellite station 40 selects the adjacent satellite stations 40N in the same orbit and transfers the packet. As a result, the satellite station 40 can transfer the packet through more reliable communication.

As described above, the satellite station 40 transfers the packet to the adjacent satellite station 40N according to the position of the adjacent satellite station 40N after the certain period. For example, in a case where the position of the adjacent satellite station 40N after the certain period is closer to the destination ground station 30D than the own position, the satellite station 40 transfers the packet to the adjacent satellite station 40N. Furthermore, the satellite station 40 transfers the packet to the adjacent satellite station 40N having the same orbit as the own satellite station according to the own position and the position of the adjacent satellite station 40N after the certain period.

Furthermore, in each of the embodiments described above, in a case where direct communication with the destination ground station 30D is possible, the satellite station 40 transfers the packet to the destination ground station 30D. In this case, the satellite station 40 may receive a reception acknowledgement response (an example of a response signal) of a packet from the destination ground station 30D. As a result, the satellite station 40 can confirm that the destination ground station 30D receives the packet.

In addition, in a case where the reception acknowledgement response cannot be received, the satellite station 40 retransmits the packet to the destination ground station 30D. Alternatively, in a case where the reception acknowledgement response cannot be received even when the packet is transmitted predetermined number of times, the satellite station 40 may transmit the packet to an adjacent ground station 30N adjacent to the destination ground station 30D.

As a result, the satellite station 40 can transmit the packet to the adjacent ground station 30N in a case where the packet cannot be transferred to the destination ground station 30D due to, for example, weather, a failure, or the like. Since the adjacent ground station 30N transmits the packet to the destination terminal device 10 or the destination ground station 30D, the destination terminal device 10 can receive the packet more reliably.

Furthermore, the satellite station 40 may determine whether the packet can be directly communicated to the destination ground station 30D by utilization of the second communication. For example, the satellite station 40 transmits a beacon to the destination ground station 30D via the second communication unit 45.

In a case of receiving a reply of a beacon from the destination ground station 30D, the satellite station 40 determines that direct communication with the destination ground station 30D is possible. On the other hand, in a case where there is no reply of the beacon from the destination ground station 30D, the satellite station 40 determines that direct communication with the destination ground station 30D is not possible.

Alternatively, the satellite station 40 may determine whether the packet can be directly communicated to the destination ground station 30D according to whether the direction of the antenna unit 41 of the own satellite station and the direction of the antenna unit 31 of the destination ground station 30D can be adjusted in such a manner that the first communication can be performed.

For example, in a case where the direction of the antenna unit 41 of the own satellite station and the direction of the antenna unit 31 of the destination ground station 30D are adjusted in such a manner that the first communication can be performed, the satellite station 40 determines that direct communication with the destination ground station 30D is possible.

For example, in a case where at least one of the direction of the antenna unit 41 of the own satellite station or the direction of the antenna unit 31 of the destination ground station 30D cannot be adjusted, the satellite station 40 determines that direct communication with the destination ground station 30D cannot be performed.

Note that the satellite station 40 may acquire information indicating whether the direction of the antenna unit 31 of the destination ground station 30D is adjusted from the destination ground station 30D by using, for example, the second communication. Alternatively, the satellite station 40 may determine whether the direction of the antenna unit 31 of the destination ground station 30D is adjusted according to whether the laser transmitted by the destination ground station 30D is received at a predetermined level or higher or whether the first communication is performed.

Alternatively, the ground station 30 may cause a ground station 30, which cannot directly communicate with the satellite station 40, to be not included in the correspondence information 341. For example, in a case where there is a ground station 30 that cannot directly communicate with the satellite station 40 due to a failure, bad weather, or the like, the ground station 30 creates the correspondence information 341 without including the ground station 30 that cannot directly communicate. In other words, the ground station 30 generates the correspondence information 341 related to the ground station 30 capable of directly communicating with the satellite station 40, and performs transmission thereof to the satellite station 40.

As a result, the satellite station 40 can transfer the packet while avoiding the ground station 30 that is known in advance to be incapable of direct communication.

In this case, the ground station 30 may include information related to a time zone in which the ground station 30 can perform communication (or a time zone in which communication cannot be performed) in the correspondence information 341 and perform transmission thereof to the satellite station 40. On the basis of, for example, time information acquired from the GNSS, the satellite station 40 transfers the packet while avoiding the ground station 30 that cannot perform communication.

Note that although the satellite station 40 searches for the adjacent satellite station 40N in a case where direct communication with the destination ground station 30D is not possible in each of the above-described embodiments, the satellite station 40 may search for a ground station 30 around the destination ground station 30D.

For example, in a case where direct communication with the destination ground station 30D is not possible, the satellite station 40 determines whether there is a ground station 30 that can perform direct communication. In a case where there is no ground station 30 with which direct communication can be performed, the satellite station 40 searches for the adjacent satellite station 40N.

In a case where there is the ground station 30 with which direct communication can be performed, the satellite station 40 determines whether a distance between the ground station 30 and the destination ground station 30D is equal to or shorter than a threshold. In a case where the distance between the ground station 30 and the destination ground station 30D is longer than the threshold, the satellite station 40 searches for the adjacent satellite station 40N.

In a case where the distance between the ground station 30 and the destination ground station 30D is equal to or shorter than the threshold, the satellite station 40 transfers the packet to the ground station 30.

Note that the satellite station 40 may search for the ground station 30 with which direct communication can be performed instead of determining whether direct communication with the destination ground station 30D is possible. In this case, in a case of finding the ground station 30 with which direct communication can be performed, the satellite station 40 determines whether the found ground station 30 is the destination ground station 30D. In a case where the found ground station 30 is not the destination ground station 30D, the satellite station 40 determines whether the found ground station 30 is the ground station 30 within a predetermined distance from the destination ground station 30D.

As described above, in a case of not being able to directly communicate with the destination ground station 30D, the satellite station 40 transfers the packet to the ground station 30 within the predetermined distance from the destination ground station 30D. As a result, the satellite station 40 can transfer the packet more reliably.

Furthermore, in each of the above-described embodiments, when transmitting the packet to the adjacent satellite station 40N, the satellite station 40 may receive the reception acknowledgement response of the packet from the adjacent satellite station 40N. As a result, the satellite station 40 can confirm that the adjacent satellite station 40N receives the packet.

In addition, in a case where the reception acknowledgement response cannot be received, the satellite station 40 retransmits the packet to the adjacent satellite station 40N. Alternatively, in a case of not being able to receive the reception acknowledgement response even after transmitting the packet predetermined number of times, the satellite station 40 may search for another satellite station 40.

As a result, the satellite station 40 can transfer the packet more reliably.

Furthermore, although the satellite station 40 includes the one second communication unit 45 in each of the above-described embodiments, the satellite station 40 may include a plurality of the second communication units 45. In this case, the satellite station 40 can search for a plurality of other satellite stations 40 at a time. Note that in a case where a plurality of the adjacent satellite stations 40N is found at a time, the satellite station 40 transfers the packet to, for example, the adjacent satellite station 40N closest to the destination ground station 30D.

As a result, the satellite station 40 can shorten the time of searching for the adjacent satellite station 40N, and can shorten the packet transfer time.

Furthermore, although the satellite station 40 transfers the packet to the non-geostationary orbit satellite station 40NG in each of the above-described embodiments, the satellite station 40 may transfer the packet to the geostationary satellite station 40G.

For example, in a case where the non-geostationary orbit satellite station 40NG cannot be found around the satellite station 40, the satellite station 40 transfers the packet to the geostationary satellite station 40G. Alternatively, in a case of not being able to find the non-geostationary orbit satellite station 40NG closer to the destination ground station 30D than the own satellite station, the satellite station 40 transfers the packet to the geostationary satellite station 40G.

Even in a case where the non-geostationary orbit satellite station 40NG closer to the destination ground station 30D than the own satellite station is found, the satellite station 40 may transfer the packet to the geostationary satellite station 40G according to a posture of at least one of the non-geostationary orbit satellite station 40NG or the own satellite station.

For example, in a case where it is necessary to change the posture of at least one of the own satellite station or the non-geostationary orbit satellite station 40NG in order to transfer the packet, the satellite station 40 transfers the packet to the geostationary satellite station 40G instead of the non-geostationary orbit satellite station 40NG.

Note that in this case, the satellite station 40 is equipped with a sensor that acquires the posture of the own satellite station, and acquires the posture of the own satellite station on the basis of the sensor. Furthermore, the non-geostationary orbit satellite station 40NG is also equipped with a sensor that acquires the posture, and the satellite station 40 acquires information related to the posture of the non-geostationary orbit satellite station 40NG by, for example, the second communication using a beacon.

Furthermore, in a case where a lifetime of the packet is set, the satellite station 40 may transfer the packet to the geostationary satellite station 40G when the lifetime is equal to or less than a threshold. The packet lifetime corresponds to time to live (TTL), for example, in a case where the packet is an IP packet. In a case where a TTL field value of the packet is equal to or smaller than a threshold, the satellite station 40 transfers the packet to the geostationary satellite station 40G. Note that the packet lifetime may be, for example, an allowable delay time.

As a result, the satellite station 40 can transfer the packet more reliably even in a case where it is difficult to transfer the packet to the non-geostationary orbit satellite station 40NG.

This is because a range (cell) in which the geostationary satellite station 40G can directly communicate with the ground station 30 and the non-geostationary orbit satellite station 40NG is wider than that of the non-geostationary orbit satellite station 40NG. Thus, even in a case where it is difficult for the satellite station 40 to transfer a packet to the ground station 30 or the non-geostationary orbit satellite station 40NG, there is a case where the packet can be transferred to the geostationary satellite station 40G.

Note that the satellite station 40 may determine the geostationary satellite station 40G to be transferred from the own position. As described above, since the geostationary satellite station 40G appears to be stationary with respect to the ground station 30, the satellite station 40 can select the geostationary satellite station 40G that can be communicated from the own position.

In a case where the geostationary satellite station 40G that can be communicated from the own position cannot be selected, for example, in a case where position information of the geostationary satellite station 40G is not possessed, the satellite station 40 may search for the geostationary satellite station 40G by using, for example, a beacon, similarly to the adjacent satellite station 40N. In this case, the geostationary satellite station 40G may include first and second communication units 42 and 45, similarly to the non-geostationary orbit satellite station 40NG.

Note that the geostationary satellite station 40G that receives the packet transfers the packet to the destination ground station 30D in a case where direct communication with the destination ground station 30D is possible. On the other hand, in a case where direct communication with the destination ground station 30D is not possible, the geostationary satellite station 40G transfers the packet to either one of the other geostationary satellite station 40G or the non-geostationary orbit satellite station 40NG.

In a case where the geostationary satellite station 40G transfers the packet to the other geostationary satellite station 40G, the geostationary satellite station 40G determines the other geostationary satellite station 40G to which the packet is to be transferred on the basis of a network configuration held in advance. As described above, the geostationary satellite station 40G appears to be stationary with respect to the ground station 30. Thus, the network configuration including the geostationary satellite station 40G has little variation. Thus, the geostationary satellite station 40G transfers the packet to the other geostationary satellite station 40G, for example, on the basis of a network configuration known in advance.

In a case where the other geostationary satellite station 40G cannot be determined, for example, in a case where information related to the network configuration of the geostationary satellite station 40G is not possessed, the geostationary satellite station 40G may search for the geostationary satellite station 40G by using, for example, a beacon, similarly to the satellite station 40. In this case, the geostationary satellite station 40G may include first and second communication units 42 and 45, similarly to the non-geostationary orbit satellite station 40NG.

Furthermore, the satellite communication system S according to each of the above-described embodiments may be operated by one business operator. That is, different business operators operate different satellite communication systems S, and the packet transfer is performed between the satellite stations 40 in each of the satellite communication systems S.

Furthermore, the packet transfer may be performed between the satellite stations 40 of the different satellite communication systems S. For example, a packet may be transferred from the satellite station 40 of the satellite communication system S according to each of the embodiments of the present disclosure to the satellite station 40 of the other satellite communication system. Alternatively, a packet may be transferred from the satellite station 40 of the other satellite communication system to the satellite station 40 of the satellite communication system S according to each of the embodiments.

In this case, the other satellite communication system may or may not perform the packet transfer using the technology of the present disclosure in the system. However, the satellite station 40 of the other satellite communication system that transmits and receives packets to and from the satellite station 40 according to each of the embodiments may include first and second communication units 42 and 45 similarly to the satellite station 40 according to each of the embodiments.

In a case where the packet is transferred from the satellite station 40 of the satellite communication system S according to each of the embodiments of the present disclosure to the satellite station 40 of the other satellite communication system, the correspondence information 431 may include information related to a ground station 30 of the other satellite communication system S. As a result, the satellite station 40 according to each of the embodiments can transfer the packet to the satellite station 40 or the ground station 30 of the other satellite communication system.

The control device that controls the terminal device 10, the ground station 30, or the satellite station 40 of the present embodiment may be realized by a dedicated computer system or a general-purpose computer system.

For example, a communication program to execute the above-described operation is stored in a computer-readable recording medium such as an optical disk, a semiconductor memory, a magnetic tape, or a flexible disk and distributed. Then, for example, the program is installed in a computer and the above-described processing is executed, whereby the control device is configured. At this time, the control device may be a device outside the terminal device 10, the ground station 30, or the satellite station 40 (such as a personal computer). Furthermore, the control device may be a device inside the terminal device 10, the ground station 30, or the satellite station 40 (such as the control unit 13, the control unit 36, or the control unit 46).

Furthermore, the communication program may be stored in a disk device included in a server device on a network such as the Internet in such a manner as to be downloadable to a computer. In addition, the above-described functions may be realized by cooperation of an operating system (OS) and application software. In this case, a portion other than the OS may be stored in a medium and distributed, or the portion other than the OS may be stored in a server device and downloaded to a computer.

Furthermore, among the pieces of processing described in each of the above embodiments, a whole or part of the processing described to be automatically performed can be manually performed, or a whole or part of the processing described to be manually performed can be automatically performed by a known method. In addition, the processing procedures, specific names, and information including various kinds of data or parameters in the above document or in the drawings can be arbitrarily modified unless otherwise specified. For example, various kinds of information illustrated in each of the drawings are not limited to the illustrated information.

In addition, each component of each of the illustrated devices is a functional concept, and does not need to be physically configured in the illustrated manner. That is, a specific form of distribution/integration of each of the devices is not limited to what is illustrated in the drawings, and a whole or part thereof can be functionally or physically distributed/integrated in an arbitrary unit according to various loads and usage conditions. Note that this configuration by distribution/integration may be performed dynamically.

In addition, the above-described embodiments can be arbitrarily combined in a region in which the processing contents do not contradict each other. Furthermore, order of steps illustrated in the flowchart of each of the above-described embodiments can be modified as appropriate.

Furthermore, for example, each of the embodiments can be implemented as any configuration included in a device or a system, such as a processor as system large scale integration (LSI) or the like, a module that uses a plurality of processors or the like, a unit that uses a plurality of modules or the like, a set acquired by further addition of other functions to the unit, or the like (that is, a configuration of a part of the device).

Note that a system means a set of a plurality of components (such as devices and modules (parts)) and it does not matter whether all the components are in the same housing in each of the embodiments. Thus, a plurality of devices housed in separate housings and connected via a network, and one device in which a plurality of modules is housed in one housing are both systems.

Furthermore, for example, each of the embodiments can adopt a configuration of cloud computing in which one function is shared and processed by a plurality of devices in cooperation via a network.

### 5. CONCLUSION

Although embodiments of the present disclosure have been described above, a technical scope of the present disclosure is not limited to the above-described embodiments as they are, and various modifications can be made within the spirit and scope of the present disclosure. In addition, components of different embodiments and modification examples may be arbitrarily combined.

Also, an effect in each of the embodiments described in the present specification is merely an example and is not a limitation, and there may be a different effect.

Note that the present technology can also have the following configurations.

(1)

A communication device comprising:
a first communication unit that performs first communication using a packet with a satellite station;
a second communication unit that performs second communication using a beacon with the satellite station; and
a control unit that transmits the packet via the first communication unit to the satellite station that can perform the second communication using the beacon via the second communication unit.
   (2)

The communication device according to (1), further comprising
an acquisition unit that acquires an own position, wherein
the control unit transmits the packet to the satellite station according to the own position.
   (3)

The communication device according to (1) or (2), wherein the control unit transmits the packet to the satellite station according to a position of a ground station that is a transmission destination of the packet.

(4)

The communication device according to (3), wherein the control unit specifies a position of the ground station on a basis of correspondence information in which a destination address of the packet and the position of the ground station are associated with each other.

(5)

The communication device according to (4), wherein the control unit acquires the correspondence information from the ground station.

(6)

The communication device according to any one of (1) to (5), wherein the control unit transmits the packet to a satellite station closer to a ground station that is a transmission destination of the packet than an own position.

(7)

The communication device according to any one of (1) to (6), wherein the control unit determines the satellite station to which the packet is transmitted by using the beacon in a case of determining to transmit the packet via the first communication unit.

(8)

The communication device according to any one of (1) to (7), wherein
the control unit
performs the second communication with the at least one satellite station in advance, and
determines the satellite station, to which the packet is transmitted, from among the at least one satellite station that performs the second communication in advance.
   (9)

The communication device according to any one of (1) to (8), wherein the control unit transmits the packet to a ground station that is a transmission destination of the packet in a case where direct communication with the ground station is possible.

(10)

The communication device according to (9), in which
the control unit
receives a response signal with respect to reception of the packet from the ground station, and
retransmits the packet to the ground station in a case where the response signal is not received.
   (11)

The communication device according to (10), in which the control unit transfers the packet to an adjacent ground station adjacent to the ground station in a case where the response signal is not received even when the packet is retransmitted to the ground station predetermined number of times.

(12)

The communication device according to any one of (1) to (11), in which the control unit transmits a packet to the satellite station in a case where direct communication with a ground station that is a transmission destination of the packet is not possible.

(13)

The communication device according to any one of (1) to (12), wherein the control unit transmits the packet to the satellite station according to a position of the satellite station after a certain period.

(14)

The communication device according to any one of (1) to (13), in which the control unit transmits the packet to the satellite station a position of which satellite station after a certain period is closer to a ground station that is a transmission destination of the packet than an own position after the certain period.

(15)

The communication device according to any one of (1) to (14), wherein the control unit transmits the packet to the satellite station in a case where a difference between an orbit of an own satellite station and an orbit of the satellite station is equal to or smaller than a predetermined value.

(16)

The communication device according to any one of (1) to (15), in which the control unit transmits the packet to the satellite station close to a ground station that is a transmission destination of the packet among a plurality of the satellite stations capable of performing the first communication.

(17)

The communication device according to one of (1) to (16), wherein the control unit transmits the packet to the satellite station in a higher orbit than an own satellite station.

(18)

The communication device according to one of (1) to (17), wherein
the control unit
acquires satellite station information related to the satellite station via the second communication unit, and
transmits the packet to the satellite station in accordance with the satellite station information.
   (19)

The communication device according to (18), in which the satellite station information includes information related to at least one of a position of the satellite station, a state of the satellite station, or a free space of a buffer included in the satellite station.

(20)

The communication device according to any one of (1) to (19), further comprising
a buffer that holds the packet, wherein
the control unit
causes the buffer to hold the received packet, and
sequentially transmits the packet held by the buffer to the satellite station.
   (21)

The communication device according to any one of (1) to (20), wherein the control unit stops transmission of the packet in a case where number of times of searching for a transmission destination of the packet exceeds predetermined number of times.

(22)

The communication device according to any one of (1) to (21), wherein the first communication unit performs optical communication using a laser.

(23)

The communication device according to any one of (1) to (22), wherein the second communication unit performs optical communication using a laser.

(24)

The communication device according to any one of (1) to (22), wherein the second communication unit performs wireless communication using a radio frequency.

(25)

A communication method comprising:
performing first communication using a packet with a satellite station by a first communication unit;
performing second communication using a beacon with the satellite station by a second communication unit; and
transmitting the packet via the first communication unit to the satellite station that can perform the second communication using the beacon via the second communication unit.
   (26)

A communication system comprising:
a terminal device;
a ground station that receives a signal from the terminal device; and
a satellite station that receives the signal from the ground station, wherein
the satellite station includes
a first communication unit that performs first communication using a packet with another satellite station,
a second communication unit that performs second communication using a beacon with the other satellite station, and
a control unit that transmits the signal via the first communication unit to the other satellite station that can communication unit.
   (27)

A communication device comprising:
a communication unit that is arranged on ground and that communicates with a satellite station; and
a control unit that transmits correspondence information in which a destination address of a packet and a position of a ground station are associated with each other to the satellite station via the communication unit, wherein
the satellite station
acquires a position of the ground station that is a transmission destination of the packet on a basis of the correspondence information, and
transmits the packet to another satellite station, with which communication using a beacon is performed, in accordance with the position of the ground station.

### REFERENCE SIGNS LIST

10 TERMINAL DEVICE
11 COMMUNICATION UNIT
12, 34, 43 STORAGE UNIT
13, 36, 46 CONTROL UNIT
30 GROUND STATION
31, 41 ANTENNA UNIT
32, 42 FIRST COMMUNICATION UNIT
33 NETWORK COMMUNICATION UNIT
35, 45 SECOND COMMUNICATION UNIT
40 SATELLITE STATION
44 POSITION INFORMATION ACQUISITION UNIT
S SATELLITE COMMUNICATION SYSTEM

1. A communication device comprising:
a first communication unit that performs first communication using a packet with a satellite station;
a second communication unit that performs second communication using a beacon with the satellite station; and
a control unit that transmits the packet via the first communication unit to the satellite station that can perform the second communication using the beacon via the second communication unit.

2. The communication device according to claim 1, further comprising
an acquisition unit that acquires an own position, wherein
the control unit transmits the packet to the satellite station according to the own position.

3. The communication device according to claim 1, wherein the control unit transmits the packet to the satellite station according to a position of a ground station that is a transmission destination of the packet.

4. The communication device according to claim 3, wherein the control unit specifies a position of the ground station on a basis of correspondence information in which a destination address of the packet and the position of the ground station are associated with each other.

5. The communication device according to claim 4, wherein the control unit acquires the correspondence information from the ground station.

6. (Transfer to a satellite station closer to a destination than an own position. 0094, 0100, and FIG. 7)
The communication device according to claim 1, wherein the control unit transmits the packet to a satellite station closer to a ground station that is a transmission destination of the packet than an own position.

7. The communication device according to claim 1, wherein the control unit determines the satellite station to which the packet is transmitted by using the beacon in a case of determining to transmit the packet via the first communication unit.

8. The communication device according to claim 1, wherein
the control unit
performs the second communication with the at least one satellite station in advance, and
determines the satellite station, to which the packet is transmitted, from among the at least one satellite station that performs the second communication in advance.

9. The communication device according to claim 1, wherein the control unit transmits the packet to a ground station that is a transmission destination of the packet in a case where direct communication with the ground station is possible.

10. The communication device according to claim 1, wherein the control unit transmits the packet to the satellite station according to a position of the satellite station after a certain period.

11. The communication device according to claim 1, wherein the control unit transmits the packet to the satellite station in a case where a difference between an orbit of an own satellite station and an orbit of the satellite station is equal to or smaller than a predetermined value.

12. The communication device according to claim 1, wherein the control unit transmits the packet to the satellite station in a higher orbit than an own satellite station.

13. The communication device according to claim 1, wherein
the control unit
acquires satellite station information related to the satellite station via the second communication unit, and
transmits the packet to the satellite station in accordance with the satellite station information.

14. The communication device according to claim 1, further comprising
a buffer that holds the packet, wherein
the control unit
causes the buffer to hold the received packet, and
sequentially transmits the packet held by the buffer to the satellite station.

15. The communication device according to claim 1, wherein the control unit stops transmission of the packet in a case where number of times of searching for a transmission destination of the packet exceeds predetermined number of times.

16. The communication device according to claim 1, wherein the first communication unit performs optical communication using a laser.

17. The communication device according to claim 1, wherein the second communication unit performs optical communication using a laser or wireless communication using a radio frequency.

18. A communication method comprising:
performing first communication using a packet with a satellite station by a first communication unit;
performing second communication using a beacon with the satellite station by a second communication unit; and
transmitting the packet via the first communication unit to the satellite station that can perform the second communication using the beacon via the second communication unit.

19. A communication system comprising:
a terminal device;
a ground station that receives a signal from the terminal device; and
a satellite station that receives the signal from the ground station, wherein
the satellite station includes
a first communication unit that performs first communication using a packet with another satellite station,
a second communication unit that performs second communication using a beacon with the other satellite station, and
a control unit that transmits the signal via the first communication unit to the other satellite station that can communication unit.

20. A communication device comprising:
a communication unit that is arranged on ground and that communicates with a satellite station; and
a control unit that transmits correspondence information in which a destination address of a packet and a position of a ground station are associated with each other to the satellite station via the communication unit, wherein
the satellite station
acquires a position of the ground station that is a transmission destination of the packet on a basis of the correspondence information, and
transmits the packet to another satellite station, with which communication using a beacon is performed, in accordance with the position of the ground station.
